(19) United States
(12) Patent Application Publication
(10) Pub. No.: US 2013/0325588 A1
(43) Pub. Date: Dec. 5, 2013

(54) Method and System for Measuring the Effectiveness of Search Advertising

(71) Applicant: The Board of Trustees for the Leland Stanford, Junior, University, Palo Alto, CA (US)

(72) Inventors: Kirthi Kalyanam, Los Gatos, CA (US); Sridhar Narayanan, Cupertino, CA (US)

(21) Appl. No.: 13/910,097

(22) Filed: Jun. 4, 2013

Related U.S. Application Data
(60) Provisional application No. 61/655,069, filed on Jun. 4, 2012.

(51) Int. Cl. G06Q 30/02

(52) U.S. Cl. CPC G06Q 30/0243
USPC 705/14.42

(57) ABSTRACT

Embodiment of the present invention relate to algorithms for computing the causal effect of position in search engine advertising listings on outcomes such as click-through rates and sales orders.

### FIELD OF THE INVENTION

The present invention generally relates to the field of computer diagnostics. More particularly, an embodiment of the present invention the present invention relates to a computer implemented method for determining position effects in online advertising.

### BACKGROUND OF THE INVENTION

Search advertising has grown to be a large part of the advertising industry. Search engines such as Google sell billions of dollars of advertising on their search pages. Because so much money is being spent, it is important for advertisers to measure the effectiveness of their advertising efforts and in particular the effectiveness of bidding to win a particular position (e.g., the uppermost placement on a search results page).

Obtaining such measures is challenging in the search advertising context due to the fact that page positions are not randomly determined. This induces a selection in positions and causes simple comparisons of outcomes at different positions to be misleading. It is difficult for an advertiser to conduct controlled experiments due to the fact that positions are determined through competitive auctions and the standard econometric approaches to find the causal effects of advertising do not easily apply to the search advertising context. Furthermore, it is costly for even the search engines to run large scale experiments that are necessary to find the causal effects.

Google and other search engines conduct small scale experimentation to obtain information on causal effects, but these provide relatively unreliable estimates. These experiments are not costless either, since experimental pages are not revenue earning for the search engine. This tradeoff between revenues and robustness and reliability of estimates makes it difficult for the search engine to conduct larger scale experiments.

Therefore, there is a need for an improved methodology determining causal effects in online advertising such as the causal effects of page position and the effectiveness of advertising. There is a further need to determine causal effects at a reduced cost and with reduced effort.

### SUMMARY OF THE INVENTION

An embodiment of the present invention addresses the causal effect of position in search engine advertising listings on outcomes such as click-through rates and sales orders. Since positions can be determined through an auction, there are significant selection issues in measuring position effects. Correlational results can be biased due to the selection in position induced by strategic bidding by advertisers. Experimentation can be difficult in this situation by competitors' bidding behavior, which induces selection biases that cannot be eliminated by randomizing the bids for the focal advertiser.

A regression discontinuity approach according to an embodiment of the present invention is a feasible approach to measure causal effects in this important context. We apply an embodiment of the present invention to a unique dataset of 23.7 million daily observations containing information on a focal advertiser as well as its major competitors.

The regression discontinuity estimates according to an embodiment of the present invention show that causal position effects would be significantly underestimated if the selection of position is ignored. An embodiment of the present invention shows sharp local effects in the relationship between position and click through rates. A finding shows that there are significant effects of position on sales orders at relatively lower positions, with the top five positions not displaying position effects. Another finding shows that the effects vary across advertisers, a finding that has potential implications for theoretical work on position auctions. Differences in effects are also investigated across weekdays and weekends, and across the broad and exact match targeting options offered by Google, for example. An important finding is that while firms may be profitable in a short-term sense in their current positions, they could improve long-term profitability by moving up a position in the search advertising results.

Embodiments of the present invention are powerful in the sense that they help search engines and advertisers find true causal position effects of search advertising. Embodiments of the present invention can be readily implemented because they may not require the collection of additional data over and above what is available to search engines already. Also, embodiments of the present invention may not be complicated and difficult in implementing estimation techniques. Instead, embodiments of the present invention involve the application of a technique called Regression Discontinuity to measuring causal effects of page positions in search engine advertising.

A method of the present invention does not involve any additional data collection and does not involve sophisticated estimation techniques. Through a novel use of an estimation approach to this context, search engines and advertisers can obtain the desired causal estimates using data that are already available.

An application of an embodiment of the present invention is in measuring causal position effects in search advertising contexts. It would be of utility to both search engines and advertisers.

These and other embodiments can be more fully appreciated upon an understanding of the detailed description of the invention as disclosed below in conjunction with the attached figures.

### BRIEF DESCRIPTION OF THE DRAWINGS

The following drawings will be used to more fully describe embodiments of the present invention.

FIG. 1 depicts and an example of search advertising results.

FIG. 2 is a chart showing position effects for CTR: Pooled Across Observations—Correlational vs. RD estimates.

FIG. 3 is a chart showing position effects for CTR: Broad Match—Correlational vs. RD estimates.

FIG. 4 is a chart showing position effects for CTR: Exact Match—Correlational vs. RD estimates.

FIG. 5 is a chart showing position effects for CTR: Weekdays—Correlational vs. RD estimates.

FIG. 6 is a chart showing position effects for CTR: Weekends—Correlational vs. RD estimates.

FIG. 7 is a block diagram of a computer system on which the present invention can be implemented.

FIG. 8 is a table showing the results of certain Monte Carlo results according to an embodiment of the present invention.

FIG. 9 is a table showing treatment effects of casino promotional offers according to an embodiment of the present invention.

FIG. 10 is a table showing the results of search advertising according to an embodiment of the present invention.

FIG. 11 is block diagram of a method for regression discontinuity according to an embodiment of the present invention.

FIG. 12 is block diagram of a method for regression discontinuity according to an embodiment of the present invention.

FIG. 13 is block diagram of a method for regression discontinuity with estimated scores according to an embodiment of the present invention.

### DETAILED DESCRIPTION OF THE INVENTION

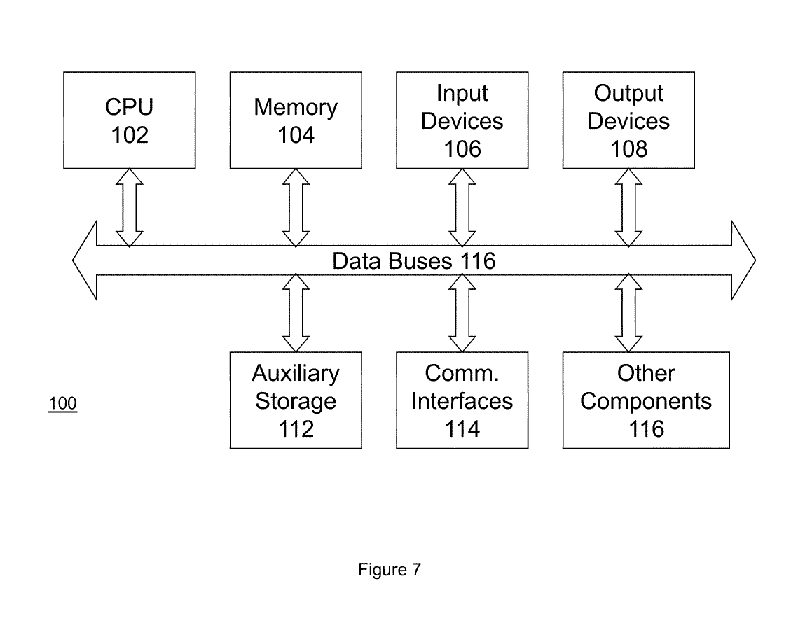

Among other things, the present invention relates to methods, techniques, and algorithms that are intended to be implemented in a digital computer system 100 such as generally shown in FIG. 7. Such a digital computer is well-known in the art and may include the following.

Computer system 100 may include at least one central processing unit 102 but may include many processors or processing cores. Computer system 100 may further include memory 104 in different forms such as RAM, ROM, hard disk, optical drives, and removable drives that may further include drive controllers and other hardware. Auxiliary storage 112 may also be include that can be similar to memory 104 but may be more remotely incorporated such as in a distributed computer system with distributed memory capabilities.

Computer system 100 may further include at least one output device 108 such as a display unit, video hardware, or other peripherals (e.g., printer). At least one input device 106 may also be included in computer system 100 that may include a pointing device (e.g., mouse), a text input device (e.g., keyboard), or touch screen.

Communications interfaces 114 also form an important aspect of computer system 100 especially where computer system 100 is deployed as a distributed computer system. Computer interfaces 114 may include LAN network adapters, WAN network adapters, wireless interfaces, Bluetooth interfaces, modems and other networking interfaces as currently available and as may be developed in the future.

Computer system 100 may further include other components 116 that may be generally available components as well as specially developed components for implementation of the present invention. Importantly, computer system 100 incorporates various data buses 116 that are intended to allow for communication of the various components of computer system 100. Data buses 116 include, for example, input/output buses and bus controllers.

Indeed, the present invention is not limited to computer system 100 as known at the time of the invention. Instead, the present invention is intended to be deployed in future computer systems with more advanced technology that can make use of all aspects of the present invention. It is expected that computer technology will continue to advance but one of ordinary skill in the art will be able to take the present disclosure and implement the described teachings on the more advanced computers or other digital devices such as mobile telephones or smart televisions as they become available. Moreover, the present invention may be implemented on one or more distributed computers. Still further, the present invention may be implemented in various types of software languages including C, C++, and others. Also, one of ordinary skill in the art is familiar with compiling software source code into executable software that may be stored in various forms and in various media (e.g., magnetic, optical, solid state, etc.). One of ordinary skill in the art is familiar with the use of computers and software languages and, with an understanding of the present disclosure, will be able to implement the present teachings for use on a wide variety of computers.

The present disclosure provides a detailed explanation of the present invention with detailed explanations that allow one of ordinary skill in the art to implement the present invention into a computerized method. Certain of these and other details are not included in the present disclosure so as not to detract from the teachings presented herein but it is understood that one of ordinary skill in the art would be familiar with such details.

### REGRESSION DISCONTINUITY

Search advertising, which refers to paid listings on search engines such as Google, Bing, and Yahoo, has emerged in the last few years to be an important and growing part of the advertising market. The order in which these paid listings are served is determined through a keyword auction, with advertisers placing bids to get specific positions in these listings, with higher positions costing more than lower positions. It is, therefore, crucial to understand the effect of position in search advertising listings on outcomes such as click-through rates and sales.

The measurement of causal position effects is challenging due to, among other things, the fact that position is not randomly determined but is rather the outcome of strategic actions by competing advertisers. Correlational inferences of position effects are potentially misleading due to selection biases. Parametric approaches to deal with these biases can be computationally demanding and typically require the availability of valid instruments with sufficient variation, which may be difficult in this context. Further, experimentation is rendered difficult since randomization of a focal advertiser's bids in the absence of randomization of competitors' bids is typically insufficient to get valid causal effects. In this disclosure, we present a regression discontinuity approach in an embodiment of the present invention for identifying causal position effects. An embodiment of the present invention it is applied to a unique dataset with information on the bids of the focal advertiser as well as its major competitors.

In the present disclosure, the term position is, generally, used as a summary statistic that search engines such as Google report to advertisers on a daily basis regarding the position of keywords during the day. Currently, Google, for example, reports the average, which is discussed in certain embodiments of the present invention. In the future, Google and other search engines might report other statistics that could then be used in accordance with the present invention as would be understood by one of ordinary skill in the art.

Further below in this disclosure, we present a regression discontinuity approach according to an embodiment of the present invention for finding causal position effects in search advertising. To be clear, however, the teachings of the present disclosure are not limited to search advertising. Indeed, the teachings of the present invention are much broader and include other applications. For example, the teachings of the present invention are applicable to other advertising schemas such as those where desired content is presented on a web-page along with advertising. Also, the present invention applicable to situations where slots or real estate on a page are a valued resource that can be sold. These and other embodiments would be obvious to those of ordinary skill in the art upon understanding the present disclosure.

In the case of search engine advertising according to an embodiment of the present invention, the position can be the outcome of an auction conducted by the search engine. In a typical auction, for instance as conducted by Google, the advertisers are ranked on a score called AdRank, which is a function of the advertisers' bids and a measure given by the search engine that is termed Quality Score. Other search engines such as Bing have a similar mechanism to decide the position of the advertisement. An embodiment of the present invention uses data for advertisements at Google, which is also the largest search engine in terms of market share. While some of the present disclosure may address Google in particular, embodiments of the present invention are more broadly applicable to other search engines and other contexts as would be understood by one of ordinary skill in the art.

In an embodiment of the present invention, considering the higher position as the treatment, the score is the difference in the AdRanks for the bidders in the higher and lower positions. If this score crosses 0, there is treatment, otherwise not. The Regression Discontinuity (RD) estimator of the effect of position finds the limiting values of the outcome of interest (e.g. click through rates or sales) on the two sides of this threshold of 0. This application satisfies the conditions for a valid RD design. As a result, in an embodiment of the present invention, valid causal effects of position are obtained.

In an embodiment, while the search engine observes the AdRanks of all the bidders, the bidders themselves only observe their own AdRanks. They observe their own bids, and the search engine reports the Quality Score to them ex-post. They can construct their own AdRanks, but they do not observe the bids or Quality Scores of their competitors. Since the score for the RD is the difference between competing bidders AdRanks, they cannot construct the score. This ensures the local randomization required for the RD design, since this non-observability of competitors AdRanks implies that advertisers cannot precisely select into a particular position. This poses a challenge to those desiring to use RD in this context. A unique dataset is used that contains information on bids and AdRanks and performance information for a focal advertiser and its main competitors.

All of these firms were major advertisers on the Google search engine, and we have a large number of observations where pairs of firms were in adjacent positions. We have historical information from these firms for a period when they operated as independent firms, with independent advertising strategies. For a large number of observations, we have AdRanks and performance measures for advertisers in adjacent positions. We are able to implement a valid RD design to measure the treatment effects. This situation is similar to the type of data that would be available to a search engine, which can report causal position effects to the advertiser.

In an embodiment of the present invention, we estimate the effect of position on two main outcomes of interest: click through rates and sales orders (e.g., whether the consumer who clicked on the search advertisement purchased at that or a subsequent occasion). We control for the keyword, advertiser, day of week and advertisement match-type to ensure that our effects are not contaminated by cross-sectional selection biases.

In an embodiment, we find that position positively affects click-through rates, with higher positions getting greater clicks. These effects are found not to be linear, with a significant effect when moving from the top most position to the next one, the next two positions being insignificantly different from each other, and again significant effects when moving below the top three positions. Further, we find that the correlational results significantly underestimate the effect of position, suggesting a negative selection bias in the case of these data. The effect of position on sales orders is positive and highly significant when moving from position 6 to 5, but all other pairs of adjacent positions are not significantly different from each other in sales orders.

In an embodiment of the present invention, we also investigate the differences in these effects between two different types of targeting options provided by Google—an exact match-type where the advertisement is served when the consumer types in the exact keyword phrase that the advertiser has bid on, and a broad match-type, where the advertisement is served for any search phrase that contains the keyword phrase the advertiser has bid on. We find that while the position effects for the broad match-type mirror the pooled results, exact match type shows much stronger effects with respect to position 1 but insignificant effects for other positions.

In an embodiment of the present invention, we compare the effects for weekdays and weekends, and find that position effects are significantly lower for weekends than weekdays. We find that there are advertiser specific differences in position effects, a finding that is of potential interest to theoretical work on position auctions. Importantly, many of these findings are missed by the correlational estimates.

In an embodiment of the present invention, we investigate, using a series of simulation studies, the practical implications of our empirical estimates by evaluating if advertisers are better off being in their current positions or would benefit by moving up a position. We find that, while in a majority of cases, firms are better off being in their current positions, this is true only in a short-run sense. In a long-run sense, our estimates according to an embodiment of the present invention suggest that firms may benefit from moving up a position. This is an important finding. Also, it was found that advertiser specific effects are important for many reasons including as a diagnostic of the health of the brand in terms of consumer search behavior.

Background on Search Advertising

Search advertising involves placing text ads, for example, on the top or side of the search results page on search engines. An example is shown in Figure lof the results of a search for the phrase “golf clubs” on Google. Search advertising is a large and rapidly growing market. For instance, Google reported revenues of almost $8.5 billion for the quarter ending Dec. 31, 2010, with a growth of 26% over the same period in the previous year. The revenues from Google's sites, primarily the search engine, accounted for two-thirds of these revenues. According to the Internet Advertising Bureau, $12 billion was spent in the United States alone on search advertising in 2010. Search advertising is the largest component of the online advertising market, with 46% of all online advertising revenues in 2010. Despite the fact that it is a relatively new medium for advertising, it already accounted for over 9% of total advertising spending (at about $131 billion for 2010), is the fourth largest medium after TV, Radio, and Print, and grew at a faster rate than the industry as a whole (12% vs. 6.5% in 2010).

Several features of search advertising have made it a very popular online advertising format. Search ads can be triggered by specific keywords (search phrases). For example, consider an advertiser who is selling health insurance for families. Some of the search phrases related to health insurance could include “health insurance,” “family health insurance,” “discount health insurance,” and “California health insurance.” The advertiser can specify that an ad will be shown only for the phrase “family health insurance.” Further, these ads can be geography specific, with potentially different ads being served in different locations. This enables an advertiser to obtain a high level of targeting.

Search advertising is sold on a “pay for performance” basis, with advertisers bidding on keyword phrases. The search engine conducts an automated online auction for each keyword phrase on a regular basis, with the set of ads and their order being decided by the outcome of the auction. Advertisers only pay the search engine if a user clicks on an ad and the payment is on a per click basis (hence the commonly used term—PPC or pay per click for search advertising). By contrast, online display advertising is sold on the basis of impressions, so the advertiser pays even if there is no behavioral response. In search advertising, advertisers are able to connect the online ad to the specific online order it generated by matching cookies. The combination of targeting, pay for clicks and sales tracking make the sales impact of search advertising highly measurable. This creates strong feedback loops as advertisers track performance in real time and rapidly adjust their spending.

Advertisers bid on keywords, with the bid consisting of the amount that the advertiser would pay the search engine every time a consumer clicked on the search ad. Since the search engine gets paid on a per click basis, the search engine's revenue would be maximized if the winning bidder has a higher product of bid and clicks. Google ranks bidder, not on their bids, but on a score called AdRank, which is the product of bid and a metric called Quality Score assigned by Google. While the exact procedure by which Google assigns a Quality Score to a particular ad is not publicly revealed, it is known that it is primarily a function of expected click through rates (which Google knows through historical information combined with limited experimentation), adjusted up or down by factors such as the quality of the landing page of the advertiser. The positions of the search ads of the winning bidders is then in descending order of their AdRanks. The winning bidder pays an amount that is just above what would be needed to win that bid. The cost per click of the winning bidder in position i is given by

$${OPC}_{i} = \frac{{Bid}_{i + 1} \times Quality {Score}_{i + 1}}{Quality {Score}_{i}} + ɛ \qquad ( 1 )$$

where ε denotes a very small number.

Position Effects

One of the most important issues in search advertising is the position of the ad on the page. Since the position of an ad is the outcome of an auction, higher positions cost more for the advertiser, everything else remaining equal, and hence would be justified only if they generate higher returns for the advertiser. Measurement of causal position effects is of importance to the advertiser.

A variety of mechanisms can lead to positions affecting outcomes such as clicks and sales. One mechanism could be that of signaling. In this mechanism, which might be most relevant for experience goods, advertisers with higher quality goods spend greater amounts on advertising in equilibrium, and consumers take advertising expenses as a signal of product quality. Since it is well known that advertisers have to spend more money to obtain higher positions in the search advertising results, consumers might infer higher positions as a signal of higher quality.

A second mechanism might relate to consumers' learned experience about the relationship between position and the relevance of the advertisement. The auction mechanism of search engines such as Google inherently scores ads with higher relevance higher. Over a period of time, consumers might have learned that ads that have higher positions are more likely to be relevant to them. Since consumers incur a cost (in terms of time and effort) each time they click on a link, they might be motivated to click on the higher links first given their higher expected return from clicking higher links. Such a mechanism is consistent with a sequential search process followed by the consumer, where they start with the ad in the highest position and move down the list until they find the information they need. Using an analytical model, it is viable equilibrium for advertisers with higher relevance to be positioned higher and consumers to be more likely to click on higher positions. It, however, may be optimal for firms to not be ranked in order of relevance or quality, and clicks to also not necessarily be higher for higher placed search ads.

A third mechanism that could drive position effects is that of attention. Several studies have pointed to the fact that consumers pay attention only to certain parts of the screen. Using eye-tracking experiments, these studies show that consumers pay the greatest attention to a triangular area that contains the top three ad positions above the organic results and the fourth ad position at the top right. Such an effect is particularly pronounced on Google and is often called the Google golden triangle. The reasons for such an effect may be due to spillovers from attention effects for organic (unpaid) search results. The organic search results are sorted on relevance to consumers, and consumers may focus their attention first on the top positions in the organic search results. Since search advertising results are above or by the side of organic search results, consumers' attention might be focused on those ads that are closest to the organic results they are focused on. In addition to the economic mechanisms such as signaling and relevance, there might be behavioral mechanisms for position effects.

Matching Options on a Search Engine

Google, which brands its search advertising product as Adwords, provides targeting options to advertisers, for example. When bidding on keywords, advertisers can specify the match-type of the ad. Some matching options available currently to advertisers on Google are broad match and exact match, with broad match being the default option. An ad that is classified as a broad match is shown as long as one of the words in the ad phrase is in the search phrase entered by the consumer. An example of a broad match keyword phrase and the kinds of ads that might be shown is in Table 1. As this example shows, in broad match the ad is eligible to be shown when any of the keywords for the ad appears in the search query. They can be in any order, singular or plural forms, synonyms and other variations. By contrast, if the advertiser specifies an exact match, the ad is served to the consumer only if the keywords are contained in the consumer's search phrase exactly. It does not allow for variations including order, singular vs. plural or synonyms.

TABLE 1
Example of broad match keyword phrase

| Keyword phrase entered | |
|---|---|
| by the consumer | Ads may be shown for |
| Tennis Shoes | Tennis |
| | Shoes |
| | Buy Tennis Shoes |
| | Tennis Shoes Photos |
| | Running Shoes |
| | Tennis Sneakers |

Table 2 illustrates an exact match situation, pointing to ads that will be served and that would not be served. Note that all the ads that would not be served in the exact match example in Table 2 would have been served if the ad were a broad match type as in Table 1.

TABLE 2
Example of an exact match keyword phrase

| Keyword phrase entered | | Ads will not |
|---|---|---|
| by the consumer | Ads may be shown for | be shown for |
| Tennis Shoes | Tennis Shoes | Running Shoes |
| | Buy Tennis Shoes | Tennis Shoe |
| | Tennis Shoes Photos | Shoes Tennis |

Google's Adwords website highlights several benefits of broad match. The claim is that it generates increased traffic and conversions, with a third of all clicks and conversions on Google being for broad match keywords. A reference is made to the fact that consumer search behavior is unpredictable, and hence it may be difficult to anticipate the exact keywords consumers may be searching for at a particular point in time. Broad match keywords, which by nature accommodate variation in the keywords consumers are searching for, can allow ads to be served in many situations where the advertiser may have failed to anticipate the exact keyword match consumers are searching for. Third, Google claims to have an automatic mechanism by which global traffic trends for search phrases are analyzed and the ad is served only for the higher performing phrases, with the lower performers automatically discarded. Another benefit is that for broad match, the organic listing for the advertiser may be lower on average than in the exact match case, potentially increasing the incremental impact of the search ad.

Broad match advertisements are typically more expensive, since for a given keyword, the click through rates are likely lower for broad match than exact match. Since the Quality Score is a function mainly of expected click through rates, a broad match ad needs a higher bid than an exact match ad for a given desired level of the AdRank. It would be more expensive for a broad match ad to obtain a given position in the advertising listings than an exact match ad.

Since broad match ads are less targeted, the ad copy also tends to be less targeted. Because search engines such as Google automatically highlight the search phrase in the ad copy, a consumer can detect broad match ads by inspecting the ad copy. As a result, the click through rates for broad match are likely to be lower. A consequence of lower click through rates is that it lowers the quality score. A broad match ad needs a higher bid than an exact match ad for a given desired level of AdRank, making broad match ads more expensive. Another consequence of lower targeting could be weaker position effects for broad match ads. Since broad match ads are less targeted, consumers might rely less on position in terms of searching through broad match ads. Another consequence of weaker targeting is that position effects for broad match ads are weaker. In general, the costs and benefits of broad match ads are not well understood. Given the importance of this issue to advertisers, we investigate if position effects differ between broad and exact match ads.

Weekend Effects

Retail environments can experience see a significant difference in purchase behavior between weekdays and weekends. Such effects, and particularly their relationship with retail pricing, has received some attention. The argument for lower prices in the weekends, which are periods of higher demand, is explained on the basis of lower search and transportation costs relative to weekdays, leading to more intensive search and hence lower prices offered by competing retailers in equilibrium. Some argue that since online retail environments significantly reduce search costs across the board both on weekdays and weekends, the price differential between weekdays and weekends should be reduced, and find empirical evidence for this.

The differences in search costs between weekdays and weekends has some bearing on advertising effects. For example, if there is any difference in search costs between weekdays and weekends, it should affect position effects of advertising. Recall that one rationale for positions effects in the first place is that consumers might sequentially search through the search advertising listings, starting at the high positions, which have higher expected returns for them, and stopping when the expected benefit from further search is lower than the expected cost. If search costs are lower in the weekends due to greater time available to the consumer, it would imply that consumers continue to search for longer periods, running further down the advertising listings on weekends than on weekdays. By this rationale, position effects should be weaker over the weekends than on weekdays.

By the same rationale of lower search costs over the weekends, consumers might have more time to search through organic listings during the weekends than on weekdays. Furthermore, in the case of product categories that are also sold offline in brick and mortar stores, they may have greater ability to search offline for the goods they are looking for on the weekends. Added to this is the fact that consumers who wish to shop offline over the weekends may pre-shop online before the weekend. The implication of these effects is that consumers might depend less on search advertising results on weekends than on weekdays. This may result in lower click through rates for search advertisements.

Selection Issues

Measuring causal position effects is important to the retailer. There may be significant selection biases in the correlational effects. First, we discuss the selection biases that may result if we compare outcomes for different positions by pooling observations across keywords, match-types, days etc, which is a common strategy in empirical work. In addition, a regression discontinuity analysis requires pooling across advertisers. Consider the case where we observe positions and outcomes for a set of keywords. It is likely that there are significant differences in click through rates or sales across different keywords. For instance, an advertiser who primarily sells tennis shoes but only a few biking shoes would likely get greater clicks for ads related to tennis shoes than biking shoes. At the same time, the ads for tennis shoes for this advertiser are likely to be in higher positions than for biking shoes, both because the expected click through rates (and hence Quality Scores) are higher for these ads, and potentially because the advertiser has greater advertising budgets for ads for tennis shoes, leading to higher bids. These two effects both raise the advertiser's AdRanks for keywords related to tennis shoes. A cross-sectional analysis across keywords would pick up these systematic differences between keywords as a spurious position effect.

Similarly, there could be selection biases when pooling observations across broad and exact match types (fewer clicks and lower positions for broad match relative to exact match), different advertisers (a bigger advertiser might have higher clicks and position, leading to spurious position effects even when the true causal effect is zero) and different days of the week.

Any analysis that pools across keywords, advertisers, match-types and days of the week can give spurious effects of position. A solution to these selection issues on observables is to conduct a within keyword, within advertiser, within match-type and within day of week analysis of the position effects, which is feasible if we have panel data. If we repeatedly observe ads for the same advertiser, keyword, match-type and day of week, we can include fixed effects (or equivalently use the differences between the outcomes and their average values for a given keyword, match-type, advertiser and day of week combination) to control for selection on observables.

Selection on Unobservables

In addition to selection biases for observables, there is potential for selection on unobservables. For example, selection may also be induced by the typical processes used by advertisers to set their bids. One mechanism that is often used by advertisers sets a fixed advertising to sales ratio for deciding advertising budgets. In the search engine context, this mechanism involves a continuous feedback loop from performance measures to bidding behavior. As sales per click increases, advertisers might automatically increase advertising budgets, which in turn increases their bid amounts and hence ensures higher positions for their ads. Similarly, as sales drop, advertising budgets and eventually position also fall. Such a mechanism would induce a positive bias in position effects, as higher position might be induced by increasing sales rather than the reverse.

A negative bias is also feasible due to potential rules used by advertisers in setting their bids. Consider an advertiser who has periodical sales, with higher propensity of consumers to visit their sites even without search advertising during that period (through other forms of advertising or marketing communication, such as catalogs for instance). The advertiser may in this instance reduce their search advertising budgets if they believe that they would have got the clicks that they obtain through search advertising anyway, and without incurring the expense that search advertising entails. They may generate high clicks and sales, even though their strategy is to spend less (and hence obtain lower positions) on search advertising during this period. This mechanism would induce a negative bias on estimates of position effects.

Another potential cause for selection biases is competition. Since search advertising positions are determined through a competitive bidding process, the bidding behavior of competitors could also induce biases in correlational estimates of position effects. Consider a competing bidder who offers similar products and services as the focal advertiser, with data on the competing bidder unavailable to the latter. Due to mechanisms similar to those described above, competing bidders may place high or low bids when their sales are high. Since the competing bidder offers similar products as the focal advertiser, higher sales for the competing bidder, for instance due to a price promotion, may lower the sales for the focal advertiser. Even click through rates for the focal advertiser could be affected if the search advertising listing for the competitor mentions that there is a price promotion at that website. At the same time, the competing bidder may place a low bid on the keyword auction through a similar set of mechanisms as the ones described above, pushing the focal advertiser higher in position. This negative correlation between position and sales for the focal advertiser induced by the price promotion at the competing advertiser's website and the unobserved strategic bidding behavior by the competitor would be picked up as a position effect. In general, any unobservables that affect positions through the bidding behavior of the competing advertiser may also affect outcomes such as sales and click through rates for the focal advertiser, and this would induce selection biases.

There are significant selection issues that may render correlational estimates of positions highly unreliable with unpredictable signs and magnitude of the biases induced by selection on unobservables.

Applying Regression Discontinuity to Finding Position Effects

In an embodiment of the present invention, regression discontinuity designs are employed to measure treatment effects when treatment is based on whether an underlying continuous score variable crosses a threshold. In an embodiment, under the condition that there is no other source of discontinuity, the treatment effect induces a discontinuity in the outcome of interest at the threshold. The limiting values of the outcome on the two sides of the threshold are unequal and the difference between these two directional limits measures the treatment effect. A desirable condition for the application of the RD design is that the score itself is continuous at the threshold. This is achieved in the typical marketing context if the agents have uncertainty about the score or the threshold.

Formally, let y denote the outcome of interest, x the treatment, and z the score variable, with z̅ being the threshold above which there is treatment. Further define the two limiting values of the outcome variable as follows

$$\begin{matrix}{y}^{+} = {Lim}_{λ -> 0} E [ y \vert z = \overline{z} + λ ] & ( 2 ) \\ {y}^{-} = {Lim}_{λ -> 0} E [ y \vert z = \overline{z} - λ ] & ( 3 )\end{matrix}$$

Then the local average treatment effect is given by

d=y⁺−y⁻ (4)

Practical implementation of RD according to an embodiment of the present invention involves finding these limiting values non-parametrically using a local regression, often a local linear regression within a pre-specified bandwidth λ of the threshold z̅ and then assessing sensitivity to the bandwidth. More details on estimating causal effects using RD designs, including the difference between sharp and fuzzy RD designs, the selection of nonparametric estimators for y+ and y, the choice of bandwidth λ and the computation of standard errors would be understood by those of ordinary skill in the art.

RD in the Search Advertising Context

As described above, positions in search advertising listings are determined by an auction with bidders ranked on a variable called AdRank, which, in turn, is the product of the bid and the Quality Score assigned by Google to the bidder for each specific keyword phrase for a particular match-type. According to an embodiment of the present invention, the application of RD to this context relies on knowledge of the AdRank of competing bidders for a given position. Specifically, if bidder A gets position in the auction and bidder B gets position i+1, it must be the case that

AdRankᵢ>AdRankᵢ₊₁ (5)

or, in other words,

ΔAdRankᵢ≡(AdRankᵢ−AdRankⁱ⁺¹)>0 (6)

According to an embodiment of the present invention, the score for the RD design is this difference in AdRanks and the threshold for the treatment (e.g., the higher of the two positions) is 0. The RD design measures the treatment effect by comparing outcomes for situations when ΔAdRankᵢ is just above zero and when it is just below zero. It compares situations when the advertiser just barely won the bid to situations when the advertiser just barely lost the bid. This achieves the quasi-experimental design that underlies RD, with the latter set of observations acting as a control for the former.

According to an embodiment of the present invention, for an RD design to be valid, it should be the case that the only source of discontinuity is the treatment. One consequence of this condition is that RD is invalidated if there is selection at the threshold. If it is the case that an advertiser can select his bid so as to have an AdRank just above the threshold, the RD design could be invalid. What comes to our assistance in establishing the validity of RD is the second price auction mechanism used by Google for example. As per this mechanism, the winner actually pays the amount that ensures that its ex post AdRank is just above that of the losing bidder. Specially, the cost per click for the advertiser is determined as in equation 1, and this ensures that ex post, the following is true.

ΔAdRankᵢ≡(AdRankᵢ−AdRankᵢ₊₁)>ε (7)

where ε is a very small number. An important consequence of this modified second price mechanism is that it is approximately optimal for advertisers to set bids so that they reflect what the position is worth to them as opposed to setting bids such that they are just above the threshold for the position.

Further, AdRanks are unobserved ex ante by the advertiser. Their own AdRanks are observed ex post, since Google reports the Quality Score on a daily basis at the end of the day, and the advertiser observes only his own bid ex ante. AdRanks of competitors are not observed even ex post. The advertiser cannot strategically self-select to be on one side of the cutoff. Occasions when the advertiser just barely won the bid and when he barely lost the bid can be considered equivalent in terms of underlying propensities for click throughs, sales, etc. Any difference between the limiting values of the outcomes on the two sides of the threshold can be entirely attributed to the position. The fact that AdRanks of competitors are unobserved satisfies the conditions for validity of RD with the advertiser being uncertain about the score (ΔAdRank).

Historically, only the search engine observes the AdRanks for all advertisers. Therefore, the RD design could be applied by the search engine, but not by advertisers, or by researchers who have access to data only from one firm. Unfortunately, search engines like Google are typically unwilling to share data with researchers, partly due to the terms of agreement with their advertisers. For purposes of validating embodiments of the present invention, however, we have access to a dataset where we observe AdRanks for four firms in the same category. One of these firms acquired the three other firms in this set, and hence we have access to data from all firms, including from a period where they operated and advertised independently.

As discussed above, selection is also induced by observables which can lead to spurious estimates. A regression framework can account for this by including fixed effects for advertiser, keyword, match-type and day of week. The most general specification would include a fixed effect for every combination of these variables. An equivalent estimator is a differenced specification where the mean differenced outcome (e.g., with the mean of outcome for each unique combination of these observable variables subtracted from the outcomes corresponding to that combination of variables). The position effect, which compares these differenced outcomes across positions is a within estimator. This idea can be extended easily to the RD design by comparing the limiting values of the mean differenced outcome variable on the two sides of the threshold. This is the estimator we use in an embodiment of the present invention. In an embodiment, we develop an RD estimator that includes a fixed effect for every unique combination of advertiser, keyword, match-type and day of week to obtain causal position effects.

We now discuss the role of other unobservables in this approach according to an embodiment of the present invention. In an embodiment, we have observations for four firms in the category, which constitute an overwhelming share of sales and search advertising in this market. It is possible, however, that there are other advertisers that we do not observe in our dataset. This is not problematic in our context, since our analysis is only conducted on those sets of observations where we observe AdRanks for pairs of firms within our dataset. Since our interest is in finding how position affects outcomes, everything else remaining constant, in an embodiment of the present invention, we conduct a within firm, within keyword, within match-type and within day-of-week analysis, with the AdRank data for the firms and competitors only used to classify which observations fall within the bandwidth for the RD design. The presence of other firms not in our dataset does not affect our analysis. In general, as long as there is no discontinuity in any of the unobservables on the two sides of the ΔAdRank threshold of 0, the RD design is valid.

Implementing the RD Design to Measure Position Effects

Here, we describe how to implement the RD design to measure the effect of position on click-through rates according to an embodiment of the present invention. An analogous procedure can be set up to measure position effects on other outcomes such as conversion rates, sales, etc.

Consider the case where we wish to find the effect of moving from position i+1 to position i on the click through rate. Note that the (i+1)^{th} position is lower than the i^{th} position. Let CTRⱼₜ refer to the click through rate for the advertiser j at time period t, AdRankⱼₜ refers to the AdRank for that advertiser at that time, and posⱼₜ refers to the position of the advertiser in the search engine listings. According to an embodiment of the present invention, the following steps are involved in implementing the RD design to measure the incremental click through rates of moving from position i+1 to position i.

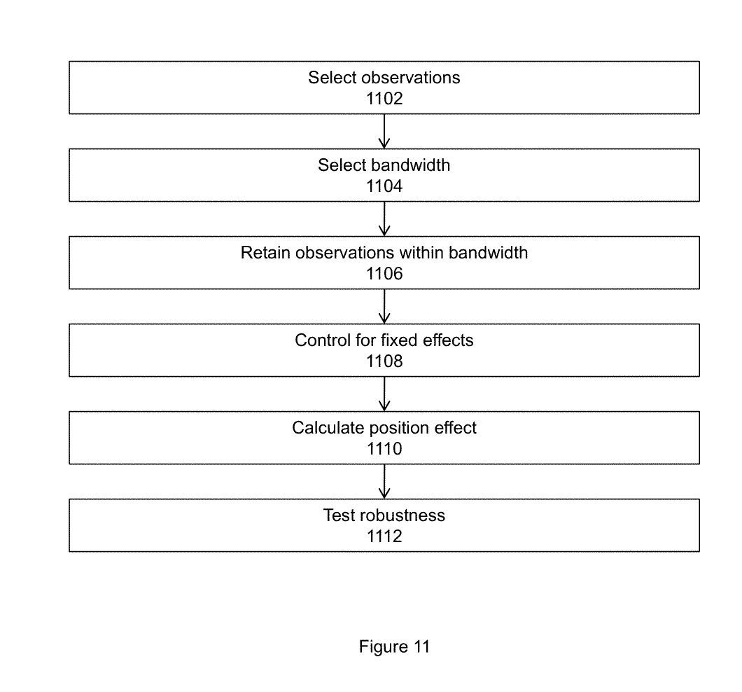

Shown in FIG. 11 is a flow diagram of method steps for implementing a Regression Discontinuity estimator for the position effects of search advertising according to an embodiment of the present invention. It should be noted that the described embodiments are illustrative and do not limit the present invention. For example, to the extent certain exemplary steps are described with reference to a particular search engine, such steps are to be understood as generally applicable to other search engines. It should further be noted that the method steps need not be implemented in the order described. Indeed, certain of the described steps do not depend from each other and can be interchanged. For example, as persons skilled in the art will understand, any system configured to implement the method steps, in any order, falls within the scope of the present invention.

As shown in FIG. 11, at step 1102, observations are selected for which AdRanks for competing bidders in adjacent positions are observed. In an embodiment, step 1102 is performed because the score variable for the RD design is the difference between the AdRanks of adjacent advertisers, e.g., ΔAdRank. For example, in an embodiment, for an advertiser in position i, ΔAdRankⱼₜ is the difference between that advertiser's AdRank and that of the advertiser in position i+1 and has a positive value. For an advertiser in position i+1, ΔAdRankⱼₜ is the difference between the advertiser's AdRank and that of the advertiser in position i and has a negative value.

At step 1104, a bandwidth λ is selected for the RD. In an embodiment, this selection can be a small number, say 5% of a standard deviation of the observed ΔAdRanks for that pair of positions. Further below, we will assess robustness of results to the selection of bandwidth.

At step 1106, observations with score within the bandwidth are retained. In an embodiment, the RD design compares observations for which 0<ΔAdRank<λ with those for which −λ<ΔAdRank<0. In an embodiment, observations for which |ΔAdRank|<λ are retained.

At step 1108, the method according to an embodiment of the present invention controls for fixed effects. In an embodiment, this is performed by finding the mean-differenced value of the outcome variables. Other schemes can be implemented in order to control for fixed effects. To understand this further, suppose we wish to include a fixed effect for every combination of advertiser, keyword, keyword match-type and day of week. In an embodiment, we let the mean value of the click through rate for all observations that are for the same advertiser, keyword, match-type and day of week be given by C\ddot{T}Rⱼₜ. In this embodiment, the mean differenced value is then

C\ddot{T}Rⱼₜ=CTRⱼₜ−C\ddot{T}Rⱼₜ.

At step 1110, the method according to an embodiment of the present invention finds the position effect. In an embodiment, this is performed by computing the two limiting values of the mean-differenced click through rates on the two sides of the cutoff. An estimator of the limiting values can be a standard non-parametric regression estimator. For example, let the kernel be denoted by K(u) such that ∫K(u)du=1. Then, the limiting value of the click through rate on the right of cutoff of 0 can be estimated as

$$C T {R}_{i}^{+} = \frac{{\sum }_{r : {AdRank}_{r} > θ} {( \tilde{C T R} )}_{r} K ( {AdRank}_{r} )}{{\sum }_{r : {AdRank}_{r} > 0} K ( {AdRank}_{r} )} \qquad ( 8 )$$

where r indexes an observation. In this embodiment, the estimator of the limiting value is a kernel-weighted average of the CTRs for all observations within the bandwidth on the right of the cutoff of 0. For a rectangular kernel for which K(u)=0.5 for −λ<u<λ, this reduces to an average of CTRs for all observations on the right and within a bandwidth of the cutoff. Similarly, in this embodiment, the estimator CTRᵤ⁻ of the limiting value of CTR on the left of the threshold can be obtained.

Alternatively, a local polynomial regression can be used as known to those of ordinary skill in the art. For instance, a local linear regression can be used to estimate the limiting values of the outcome variable. In an embodiment of the present invention, we conduct such a local linear regression to obtain our RD estimates but find that the results are very close to the estimator described above. We report the estimates using this approach according to an embodiment of the present invention.

In an embodiment, the position effect using a uniform kernel for the CTR is

$$( i + 1 ) -> i = \frac{1}{{N}_{i}} {\sum }_{r ∈ {Ω}_{i}} C T {R}_{r} - \frac{1}{{N}_{i + 1}} {\sum }_{r ∈ {Ω}_{i + 1}} {( \tilde{C T R} )}_{r}$$

$$where$$

$${Ω}_{i} = \{ r \vert {pos}_{r} = {i}_{r} \vert Δ {AdRank}_{r} \vert < λ \}$$

and Nᵢ is the number of observations in Ωᵢ. The standard errors for this estimator are computed as

$$std . err . ( i + 1 ) -> 1 = \sqrt{\frac{{var}_{i}}{{N}_{i}} + \frac{{var}_{i + 1}}{{N}_{i + 1}}}$$

where the variance

$${var}_{i} = \frac{1}{{N}_{1}} {\sum }_{r ∈ {Ω}_{i}} {\tilde{C T R}}_{r}^{2} - {( \frac{1}{{N}_{i}} {\sum }_{r ∈ {Ω}_{i}} {( \tilde{C T R} )}_{r} )}^{2} .$$

The position effect for other outcomes such as sales can be computed in a similar fashion.

At step 1112, a test for robustness is performed for the assumption of bandwidth λ. In an embodiment, this is performed by checking whether parameters change very much when the bandwidth is changed. In general, the analyst faces a tradeoff between bias and efficiency of estimates—a larger bandwidth might reduce the standard errors of estimates, but at the cost of increased bias. In an application of the present invention, the results are robust to bandwidths in a relatively wide range. In an embodiment, we take an approach of selecting a small bandwidth and then checking for sensitivity of results to this selection in an embodiment of the present invention.

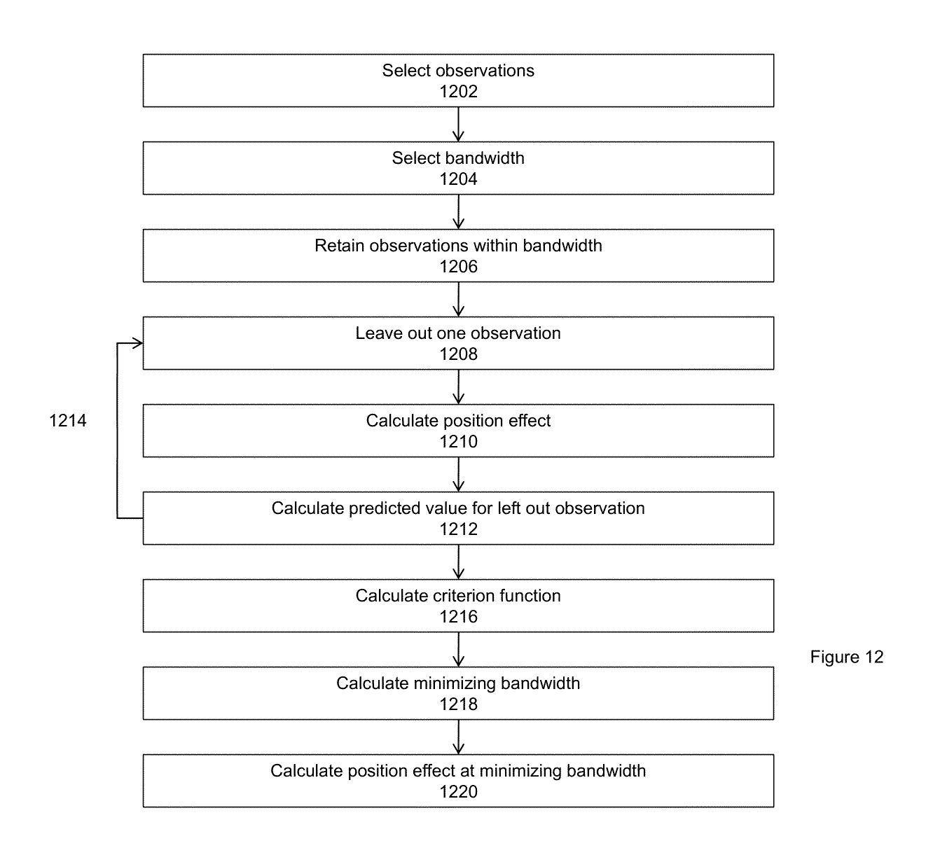

Shown in FIG. 12 is flow diagram of method steps for implementing a Regression Discontinuity estimator for the position effects of search advertising according to another embodiment of the present invention. It should be noted that the described embodiments are illustrative and do not limit the present invention. For example, to the extent certain exemplary steps are described with reference to a particular search engine, such steps are to be understood as generally applicable to other search engines. It should further be noted that the method steps need not be implemented in the order described. Indeed, certain of the described steps do not depend from each other and can be interchanged. For example, as persons skilled in the art will understand, any system configured to implement the method steps, in any order, falls within the scope of the present invention.

For the method of FIG. 12, consider a pair of adjacent positions, say positions k and k+1, where the k^{th} position is higher up in the search advertising listings than the k+1^{th} position. At step 1202, observations are selected for which AdRanks for competing bidders in adjacent positions are observed. In an embodiment, step 1202 is performed because the score variable for the RD design is the difference between the AdRanks of adjacent advertisers, e.g., ΔAdRank. For example, in an embodiment, for an advertiser in position i, ΔAdRankⱼₜ is the difference between that advertiser's AdRank and that of the advertiser in position i+1 and has a positive value. For an advertiser in position i+1, ΔAdRankⱼₜ is the difference between the advertiser's AdRank and that of the advertiser in position i and has a negative value.

At step 1204, a bandwidth λ is selected for the RD. In an embodiment, this selection can be a small number, say 5% of a standard deviation of the observed ΔAdRanks for that pair of positions. Further below, we will assess robustness of results to the selection of bandwidth.

At step 1206, observations with score within the bandwidth are retained. In an embodiment, the RD design compares observations for which 0<ΔAdRank<λ with those for which −λ<ΔAdRank<0. In an embodiment, observations for which |ΔAdRank|<λ are retained. In an embodiment, the number of retained observations is the number N.

At step 1208, one observation is left out of the set of observations selected within the bandwidth. For example, in an embodiment, the n^{th} observation is left out.

At step 1210, a position effect is estimated using a non-parametric kernel regression using the set of N−1 observations, e.g., the observations within the bandwidth but excluding the n^{th} observation. In an embodiment, a local linear regression with a uniform kernel is used that simplifies the estimator to the regression

yᵢ=α+β·positionᵢ+γ·ΔAdRankᵢ+δ·ΔAdRank·positionᵢ+μ·Xᵢαεᵢ.

Here, yᵢ is the outcome of interest for the i^{th} observation, for instance the click through rate or sales. The position effect is given by ε. The ε and δ terms respectively control for the systematic variation of the outcome with the score and how this potentially differs in the two positions. The term Xᵢ includes other controls, including fixed effects. In an embodiment, these fixed effects are specified at the keyword-advertiser-match type level with separate fixed effects for day of week for example.

In an embodiment, this local linear regression can be substituted by a local non-linear regression including, for instance, higher order polynomial terms in ΔAdRankᵢ, and a non-uniform kernel where the observations are given different weights based on how far the ΔAdRankᵢ is from zero. The local linear regression outlined above according to an embodiment of the present invention is for purposes of illustration and combines simplicity with good econometric properties.

At step 1212, a computation is made of the predicted value ŷₙ of the outcome for the n^{th} observation that has been left out using the regression coefficients.

In an embodiment, steps 1208 through 1212 are repeated as shown by loop 1214 for all observations in set of N retained observations in step 1206.

At step 1216, a criterion function is calculated. In an embodiment, the criterion function is φ=Σₙ₌₁^{N}(yₙ−ŷₙ)².

At step 1218, the value of the bandwidth λ=λ* that minimizes φ is found. In an embodiment, this is performed with an optimizer algorithm as known to those of ordinary skill in the art.

At step 1220, a position effect is determined at the value of λ=λ*. In an embodiment, its standard error is also determined using the non-parametric estimator outlined in step 1210.

Data Description

Our data consist of information about search advertising for a large online retailer of a particular category of consumer durables. This firm, which is over 50 years old started as a single location retailer, expanding over the years to a nationwide chain of stores both through organic growth and through acquisition of other retailers. Since the category involves a very large number of products, running into the thousands, a brick and mortar retail strategy was dominated in terms of its economics by a direct marketing strategy. Over the years, its strategy evolved to stocking a relatively small selection of entry-level, low-margin products with relatively high sales rates in the physical stores, with the very large number of slower moving, high margin products being sold largely through the direct marketing channel. Recently, the firm acquired three other large online retailers. Two of the four firms are somewhat more broadly focused, while two others are more narrowly focused on specific sub-categories. Each of them has significant overlaps with the others in terms of products sold. For a significant period of time after the acquisition, the firms continued to operate independently, with independent online advertising strategies. Our data have observations on search advertising on Google for these four firms, and crucially for the period where they operated as independent advertisers.

We have a total number of about 23.7 million daily observations over a period of nine months in the database of which about 10.5 million observations involve cases where two or more advertisers among the set of four firms bid on the same keyword. Since the keywords are often not in adjacent positions, we filter out observations where the observations are not adjacent in an embodiment of the present invention. We also drop observations where we do not have bids and Quality Scores for both of the adjacent advertisements. Since the position reported in the dataset is a daily average, we also drop observations where the average positions are more than 0.1 positions away from the nearest integer. We are left with a total of 330,336 observations where we observe advertisements in adjacent positions, spanning 22,471 unique keyword phrase/match-type combinations. An overwhelming majority (79%) of the 22471 keywords are of the broad match-type, and the rest are of the exact match-type. There are a total of 18,875 unique keywords in this analysis dataset, with most exact match-type keywords also advertised as broad match type, but not necessarily vice versa.

Table 3 has the list of variables in the dataset (including variables we have constructed such as click through rates, conversion rates and sales per click) and the summary statistics for these variables. We report these statistics for broad match and exact match keywords, in addition to the overall summaries. Observations are only recorded on days that have at least one impression, e.g., when at least one consumer searched for the keyword phrase. Through a tracking of cookies on consumer's computers, each impression is linked to a potential click, order, sales value, margin etc. As per standard industry practice, a sales order is attributed to the last click within an attribution window with previous clicks not getting credit for these sales.

TABLE 3
Summary statistics of the data

| | All keywords | | Broad match | | Exact match | |
|---|---|---|---|---|---|---|
| Variable | Mean | Std. Dev | Mean | Std. Dev | Mean | Std. Dev |
| Impressions | 45.8977 | 225.5401 | 48.8384 | 239.5032 | 35.2865 | 166.6019 |
| Clicks | 0.5471 | 2.5304 | 0.4497 | 1.7811 | 0.8883 | 4.1941 |
| Click through rate (%) | 1.9132 | 6.7079 | 1.3726 | 5.5256 | 3.8151 | 9.5531 |
| (Clicks/Impressions) | | | | | | |
| Number of orders | 0.0046 | 0.0724 | 0.0033 | 0.0593 | 0.0093 | 0.1062 |
| Conversion rate (% of | 0.7468 | 7.3578 | 0.6291 | 6.8207 | 1.0343 | 8.5251 |
| 75593 non-zero clicks that | | | | | | |
| resulted in orders) | | | | | | |
| Sales ($) | 0.4887 | 17.0041 | 0.3514 | 14.7753 | 0.9730 | 23.2148 |
| Average Sales per | 0.7435 | 21.0691 | 0.6360 | 20.1133 | 1.0081 | 23.2670 |
| (non-zero) click ($) | | | | | | |
| Gross margin ($) | 0.1958 | 6.7226 | 0.1341 | 5.4559 | 0.4131 | 9.9757 |
| Bid ($ per click) | 0.3969 | 0.8219 | 0.3381 | 0.8676 | 0.6037 | 0.5928 |
| Quality Score | 5.9791 | 12.496 | 6.0160 | 1.2464 | 5.8518 | 1.2515 |
| AdRank | 2.3523 | 5.0899 | 2.0164 | 5.3770 | 3.5340 | 3.6961 |

On average, there are about 46 impressions per keyword phrase per day, but the dispersion in the number of impression is large, with a standard deviation of almost 226. On average, broad match keywords receive greater impressions than exact match keywords. The number of clicks are however higher for exact keywords than for broad match keywords. Virtually all performance metrics, such as clicks, click through rates, orders, conversions etc. are higher for the exact match keyword the firms advertise on than for broad match keywords. Note that the broad and exact keywords are not necessarily comparable, since the firms might be bidding on different kinds of keywords in the broad and exact cases.

Results

We conducted an analysis of the effect of position on two key metrics of interest to advertisers—click through rates (henceforth CTR) and the number of sales orders (henceforth orders). The reason to select these two metrics is that they are the most important metrics from the point of view of the advertiser. CTR measures the proportion of consumers served the ad who clicked on it and arrived at the advertiser's website. Since the advertiser's control on the consumer's experience only begins once the consumer arrives at the website, CTR is of critical importance to the advertiser in measuring the effectiveness of the advertisement in terms of driving volume of traffic. We could conduct an analysis on raw clicks instead, but it may not make any material difference to the results, and CTR is the more commonly reported metric in this industry.

The second measure we consider is the number of sales orders corresponding to that keyword. This is again a key metric for the firm since it generates revenues only when a consumer places an order. We attempted an analysis on measures like conversion rates, sales value and sales per click, but do not report these estimates since almost all the estimates were statistically insignificant. This is partly driven by the fact that the category in focus sees very infrequent purchases, reducing the statistical significance of results.

Effect of Position on Click Through Rates

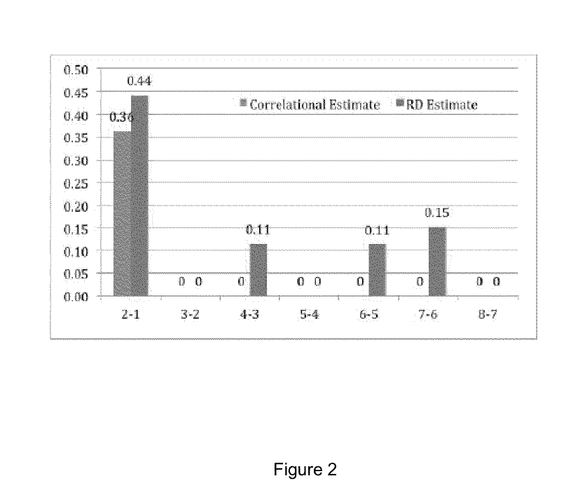

The pooled results of all advertisements in the analysis sample, with fixed effects for advertiser, keyword, match-type and day of week are reported in Table 4. FIG. 2 summarizes the position effects for click-through rates, showing both the correlational and RD estimates according to an embodiment of the present invention. We report both correlational estimates (comparisons of means across each pair of positions) and the RD estimates, with a bandwidth set at 5% of a standard deviation of the score. We report the baseline click through rates for each position, which is the click through rate for the lower position in the pair. We report these baseline numbers separately for the correlational and RD estimates, with the RD baseline representing the observations within the bandwidth.

One point to note is that these comparisons should only be conducted on a pairwise basis. For instance, the observations in position 2 that are used for analyzing the shift from position 2 to 1 are not the same as the observations used to compare 3 to 2. Hence, it will not be the case that the baseline for position 2 is the sum of the baseline for position 3 and the effect of moving from position 3 to 2.

TABLE 4
Position effects on click through rates

| | Correlational Estimates (CTR %) | | | RD Estimates (CTR %) | | |
|---|---|---|---|---|---|---|
| Posi- | Base- | Esti- | p- | Base- | Esti- | p- |
| tion | line | mate | value | line | mate | value |
| 2 to 1 | 2.1372 | 0.3633 | 0.0000 | 2.3404 | 0.4415 | 0.0106 |
| 3 to 2 | 1.3737 | 0.0163 | 0.4922 | 1.2802 | 0.0774 | 0.2059 |
| 4 to 3 | 1.1026 | −0.0124 | 0.5799 | 1.0304 | 0.1143 | 0.0142 |
| 5 to 4 | 0.8832 | 0.0186 | 0.4539 | 0.8620 | 0.0589 | 0.2078 |
| 6 to 5 | 0.7537 | 0.0085 | 0.7976 | 0.7635 | 0.1135 | 0.0236 |
| 7 to 6 | 0.5791 | 0.0626 | 0.2232 | 0.7161 | 0.1521 | 0.0378 |
| 8 to 7 | 0.4991 | −0.0339 | 0.6305 | 0.4913 | −0.0082 | 0.9459 |

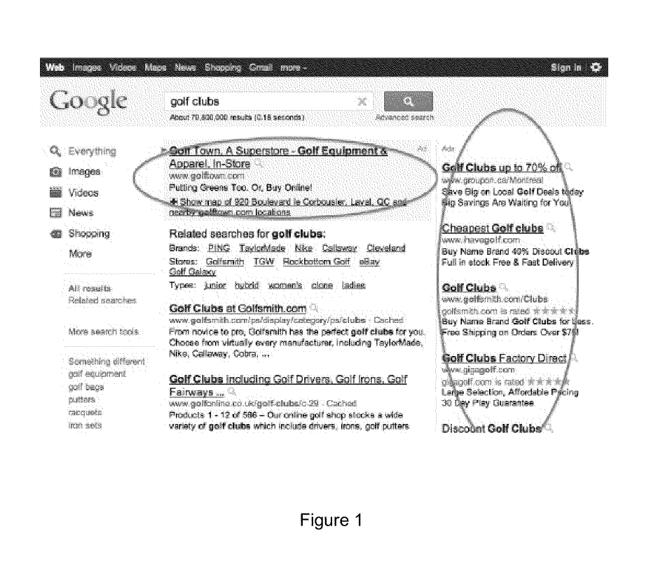

The correlational estimates would suggest that there is a significant effect only when moving to position 1. The remaining effects are statistically insignificant, e.g., all other pairs of positions have similar click through rates. When we look at the RD estimates, however, we see significant effects across multiple positions. The effects are significant when moving to positions 1, 3, 5 and 6. As seen in FIG. 1, the topmost position is often above the organic search results and distinctive relative to the other ads. The effect at position 1 is to be expected. There is no significant position effect between positions 3 and 2. There is a significant and positive effect, however, when moving from position 4 to position 3. Such an effect is consistent with the Google golden triangle effect, which has been postulated to be due to attention effects and documented in eye tracking studies as well as using advertising and sales data. Further, there seem to be significant effects when moving from positions 6 to 5 and 7 to 6. These positions are typically below the page fold and often require consumers to scroll down (whether position 6 or 5 appears below the fold depends on the size of the browser window, the number of ads that appear above the organic results, etc.).

The differences between the correlational and RD estimates are important, since they indicate the nature of the selection in positions. The fact that correlational estimates are insignificant where RD estimates are significant suggests that the selection bias is negative in the case of positions 3, 5 and 6, washing out the causal effects of these positions. This can result from advertisers or their competitors' strategic behavior, as indicated earlier. Further, the effect of selection differs significantly by position, with the magnitude of the difference between the correlational and RD estimates ranging between 0.0003 and 0.0010.

According to an embodiment of the present invention, the causal position effects are not just statistically significant, but have large economic significance as well. For instance, the causal effect at position 1 as a proportion of the baseline click through rate is 18.8%. They are 11.1%, 14.9% and 21.2% respectively at positions 3, 5 and 6, and hence of large magnitude even at these positions. In this category at least, if the objective of search advertising is to drive up clicks, it may be effective at these positions and by a large magnitude.

Effect of Position on Sales Orders

We next investigate if the position in search advertising results causally affects the number of sales orders that are generated, and report the RD estimates in Table 5 according to an embodiment of the present invention. A note of caution here is that data is sparse for orders, given the nature of the category and statistically insignificant estimates may reflect this sparsity.

TABLE 5
Position effects on number of sales orders

| | Correlational Estimates (Orders) | | | RD Estimates (Orders) | | |
|---|---|---|---|---|---|---|
| Posi- | Base- | Esti- | p- | Base- | Esti- | p- |
| tion | line | mate | value | line | mate | value |
| 2 to 1 | 0.0044 | 0.0013 | 0.0048 | 0.0044 | 0.0005 | 0.7783 |
| 3 to 2 | 0.0030 | −0.0000 | 0.9992 | 0.0026 | 0.0005 | 0.4993 |
| 4 to 3 | 0.0031 | 0.0001 | 0.8138 | 0.0033 | −0.0005 | 0.4137 |
| 5 to 4 | 0.0019 | 0.0004 | 0.3785 | 0.0016 | 0.0009 | 0.2385 |
| 6 to 5 | 0.0011 | 0.0001 | 0.8570 | 0.0009 | 0.0019 | 0.0108 |

We find that the correlational effects are once again misleading. They suggest that there are positive incremental effects on sales only when moving to the top position from the next one. By contrast, the RD estimates according to an embodiment of the present invention suggest that the only significant effect is in moving to position 5, with no significant differences between pairs of positions above that. This suggests that the nature of the mechanisms that may cause position to affect sales, such as quality signaling really play out only below the top 5 positions. In terms of economic significance, these effects are even stronger than for click through rates, with sales orders jumping up by over 200% relative to the baseline.

Broad Vs. Exact Match Types

We have earlier discussed why we might expect differences in effects between broad and exact match types. We report the RD estimates for broad and exact match types for click through rates in Table 6 according to an embodiment of the present invention. The comparisons of these two types of match types reveal an interesting asymmetry in effects. For broad match types, there are significant effects at position 3, 5, and 6 only but not at position 1. For exact match types, on the other hand, the only significant effect is at position 1. This is an important finding, and to the best of our knowledge, the first time documented tool has identified the differences between advertising response for broad and exact match types. Table 7 reports the broad and exact match type effects for sales orders. The broad match type results are similar to the pooled results, with a significant effect only at position 5, while the exact match type has no significant effects.

TABLE 6
RD estimates of position effects on click through rates: broad v. exact match

| | Pooled Estimates (CTR %) | | | Broad Match (CTR %) | | | Exact Match (CTR %) | | |
|---|---|---|---|---|---|---|---|---|---|
| Position | Baseline | Estimate | p-value | Baseline | Estimate | p-value | Baseline | Estimate | p-value |
| 2 to 1 | 2.3404 | 0.4415 | 0.0106 | 1.7547 | 0.2238 | 0.1899 | 3.2451 | 0.7823 | 0.0400 |
| 3 to 2 | 1.2802 | 0.0774 | 0.2059 | 1.1486 | 0.0687 | 0.2796 | 2.2061 | 0.1171 | 0.5873 |
| 4 to 3 | 1.0304 | 0.1143 | 0.0142 | 0.9924 | 0.1075 | 0.0219 | 1.3951 | 0.1446 | 0.4527 |
| 5 to 4 | 0.8620 | 0.0589 | 0.2078 | 0.8486 | 0.0525 | 0.2736 | 1.1598 | −0.1532 | 0.4660 |
| 6 to 5 | 0.7635 | 0.1135 | 0.0236 | 0.7773 | 0.1061 | 0.0415 | 0.8027 | 0.2051 | 0.4380 |
| 7 to 6 | 0.7161 | 0.1521 | 0.0378 | 0.7675 | 0.1409 | 0.0606 | 0.3241 | −0.3060 | 0.6988 |
| 8 to 7 | 0.4913 | −0.0082 | 0.9459 | 0.5691 | 0.0150 | 0.9105 | 0.6944 | −0.1394 | 0.8101 |

TABLE 7
RD estimates of position effects on number of sales orders: broad v. exact match

| | Pooled Estimates (Orders) | | | Broad Match (Orders) | | | Exact Match (Orders) | | |
|---|---|---|---|---|---|---|---|---|---|
| Position | Baseline | Estimate | p-value | Baseline | Estimate | p-value | Baseline | Estimate | p-value |
| 2 to 1 | 0.0044 | 0.0005 | 0.7783 | 0.0006 | −0.0002 | 0.7435 | 0.0097 | −0.0018 | 0.6505 |
| 3 to 2 | 0.0026 | 0.0005 | 0.4993 | 0.0024 | 0.0000 | 0.9585 | 0.0037 | 0.0033 | 0.1707 |
| 4 to 3 | 0.0033 | −0.0005 | 0.4137 | 0.0031 | −0.0007 | 0.2691 | 0.0057 | −0.0005 | 0.8989 |
| 5 to 4 | 0.0016 | 0.0009 | 0.2385 | 0.0016 | 0.0012 | 0.1372 | | | |
| 6 to 5 | 0.0009 | 0.0019 | 0.0108 | 0.0005 | 0.0021 | 0.0109 | | | |

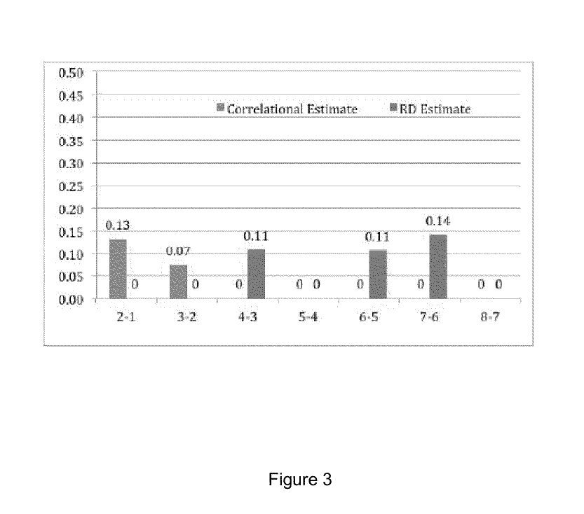

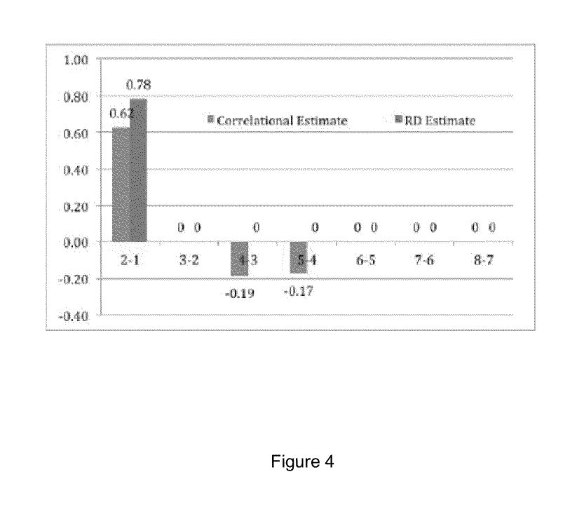

In Tables 8 and 9, we compare the correlational estimates (e.g., raw mean comparisons across positions) with the RD estimates of position effects for broad and exact match types for click through rates and orders respectively. FIGS. 3 and 4 summarize the effects. First focusing on the effects for click through rates in Table 8, we find that the correlational effects are very different from the RD estimates according to an embodiment of the present invention for the broad match type. The correlational estimates would suggest that there is a significant effect when moving from positions 2 to 1 and 3 to 2, while the RD estimates show that there are significant effects of moving to positions 3, 5 and 6 from the immediately lower positions respectively.

For exact match, the correlational estimates are significantly positive when moving from position 2 to position 1, and significantly negative at the 90% level when moving to positions 4 and 5 from 5 and 6 respectively. The RD estimates, on the other hand find significant estimates only for position 1, and in that case, the RD estimates have a higher magnitude than the correlational estimates. Looking at the comparison of correlational and RD estimates for orders in Table 9, the effects are largely insignificant, except that the correlational effects for position 1 for exact match is significantly positive, while the RD estimate is insignificant. The correlational estimates can be misleading once again with very little agreement between the correlational and RD estimates on which positions have significant effects.

TABLE 8
Comparison of correlational RD estimates for different match-types: click through rates

| | Broad Match (CTR %) | | | | Exact Match (CTR %) | | | |
|---|---|---|---|---|---|---|---|---|
| | Correlational | | RD Estimates | | Correlational | | RD Estimates | |
| Position | Estimate | p-value | Estimate | p-value | Estimate | p-value | Estimate | p-value |
| 2 to 1 | 0.1308 | 0.0014 | 0.2238 | 0.1899 | 0.6233 | 0.0000 | 0.7823 | 0.0400 |
| 3 to 2 | 0.0734 | 0.0014 | 0.0687 | 0.2796 | −0.0541 | 0.4783 | 0.1171 | 0.5873 |
| 4 to 3 | −0.0073 | 0.7429 | 0.1075 | 0.0219 | −0.0299 | 0.7505 | 0.1446 | 0.4527 |
| 5 to 4 | 0.0356 | 0.1565 | 0.0525 | 0.2736 | −0.1874 | 0.0648 | −0.1532 | 0.4660 |
| 6 to 5 | 0.0010 | 0.7848 | 0.1061 | 0.0415 | −0.1745 | 0.0943 | 0.2051 | 0.4380 |
| 7 to 6 | 0.0067 | 0.1933 | 0.1409 | 0.0606 | −0.0037 | 0.9855 | −0.3060 | 0.6988 |
| 8 to 7 | −0.0367 | 0.6236 | 0.0150 | 0.9105 | −0.0759 | 0.6768 | −0.1394 | 0.8101 |

TABLE 9
Comparison of correlational RD estimates for
different match-types: number of sales orders

| | Broad Match (orders) | | | | Exact Match (orders) | | | |
|---|---|---|---|---|---|---|---|---|
| | Correlational | | RD Estimates | | Correlational | | RD Estimates | |
| Position | Estimate | p-value | Estimate | p-value | Estimate | p-value | Estimate | p-value |
| 2 to 1 | 0.0005 | 0.2773 | −0.0002 | 0.7435 | 0.0019 | 0.0400 | −0.0018 | 0.6505 |
| 3 to 2 | 0.0003 | 0.2822 | 0.0000 | 0.9585 | 0.0001 | 0.9220 | 0.0033 | 0.1707 |
| 4 to 3 | −0.0001 | 0.7706 | −0.0007 | 0.2691 | 0.0008 | 0.5669 | −0.0005 | 0.8989 |
| 5 to 4 | 0.0005 | 0.2956 | 0.0012 | 0.1372 | | | | |
| 6 to 5 | 0.0003 | 0.5745 | 0.0021 | 0.0109 | | | | |

Weekend Effects

The results for the position effects separated by weekday and weekend are reported in Tables 10 and 11 respectively for click through rates and number of orders. The weekday results for CTR are largely similar to the pooled results, with a significant effect at position 1, 3 and 5. The weekend effects are less significant in general, partly reflecting the smaller number of observations, but also show differences in the position effects. The only marginally significant results (e.g., at 90% significance level) are at positions 4 and 6, which typically are below the usual zones of attention for consumers.

TABLE 10
RD estimates of position effects on click through rates: weekday v. weekend

| | Pooled Estimates (CTR %) | | | Weekday (CTR %) | | | Weekend (CTR %) | | |
|---|---|---|---|---|---|---|---|---|---|
| Position | Baseline | Estimate | p-value | Baseline | Estimate | p-value | Baseline | Estimate | p-value |
| 2 to 1 | 2.3404 | 0.4415 | 0.0106 | 2.4797 | 0.4395 | 0.0333 | 1.9884 | 0.4658 | 0.1405 |
| 3 to 2 | 1.2802 | 0.0774 | 0.2059 | 1.2447 | 0.1091 | 0.1193 | 1.4106 | −0.0066 | 0.9581 |
| 4 to 3 | 1.0304 | 0.1143 | 0.0142 | 1.0130 | 0.1283 | 0.0194 | 1.0859 | 0.0423 | 0.6138 |
| 5 to 4 | 0.8620 | 0.0589 | 0.2078 | 0.8211 | 0.0256 | 0.6448 | 0.9743 | 0.1637 | 0.0603 |
| 6 to 5 | 0.7635 | 0.1135 | 0.0236 | 0.7499 | 0.1448 | 0.0120 | 0.7968 | 0.0407 | 0.6899 |
| 7 to 6 | 0.7161 | 0.1521 | 0.0378 | 0.5821 | 0.1056 | 0.2009 | 1.0061 | 0.2730 | 0.0874 |
| 8 to 7 | 0.4913 | −0.0082 | 0.9459 | 0.5368 | −0.0238 | 0.8738 | 0.5444 | 0.1123 | 0.5896 |

TABLE 11
RD estimates of position effects on number of sales orders: weekday v. weekend

| | Pooled Estimates (Orders) | | | Weekday (Orders) | | | Weekend (Orders) | | |
|---|---|---|---|---|---|---|---|---|---|
| Position | Baseline | Estimate | p-value | Baseline | Estimate | p-value | Baseline | Estimate | p-value |
| 2 to 1 | 0.0044 | 0.0005 | 0.7783 | 0.0055 | −0.0004 | 0.8460 | 0.0015 | 0.0027 | 0.3106 |
| 3 to 2 | 0.0026 | 0.0005 | 0.4993 | 0.0017 | 0.0006 | 0.4377 | 0.0048 | 0.0002 | 0.8887 |
| 4 to 3 | 0.0033 | −0.0005 | 0.4137 | 0.0031 | −0.0004 | 0.5516 | 0.0038 | −0.0006 | 0.7112 |
| 5 to 4 | 0.0016 | 0.0009 | 0.2385 | 0.0022 | 0.0002 | 0.7729 | 0.0000 | 0.0033 | 0.0594 |
| 6 to 5 | 0.0009 | 0.0019 | 0.0108 | 0.0006 | 0.0008 | 0.1029 | 0.0018 | 0.0053 | 0.0454 |

The absence of significant position effects may reflect the differences in search costs of consumers between weekdays and weekends. If consumers search costs are lower on weekends, they are more likely to search lower down the advertising results before stopping, giving rise to the effects we estimate. These results are consistent with the explanation for weekend effects in offline retail categories. In terms of sales orders, there are no major directional differences between weekdays and weekends, with significant effects largely at lower positions like the 4th and 5th positions.

The weekend effects described here also provide indirect support for the search cost explanation for position effects per se, while not conclusively proving its existence or ruling out the presence of other explanations simultaneously. If position effects are driven, even partially, by a sequential search mechanism, with consumers sequentially moving down the list of search advertising results until their expected benefit from the search is lower than their cost of further search, it is a logical conclusion that they would search more when search costs are lower. Since search costs are plausibly lower on weekends, due to greater availability of time, this would lead to position effects lower down the list on weekends than on weekdays, which is what we find in our analysis according to an embodiment of the present invention.

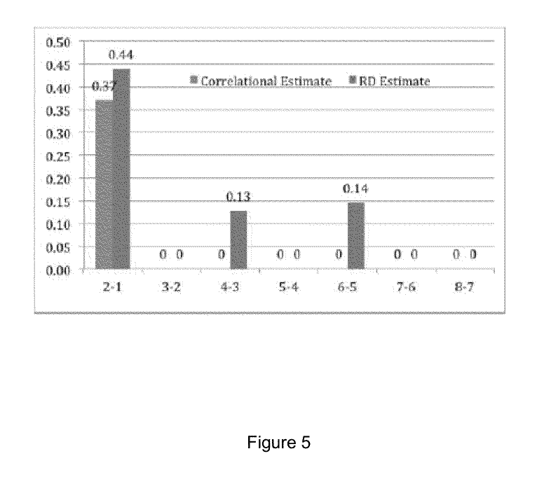

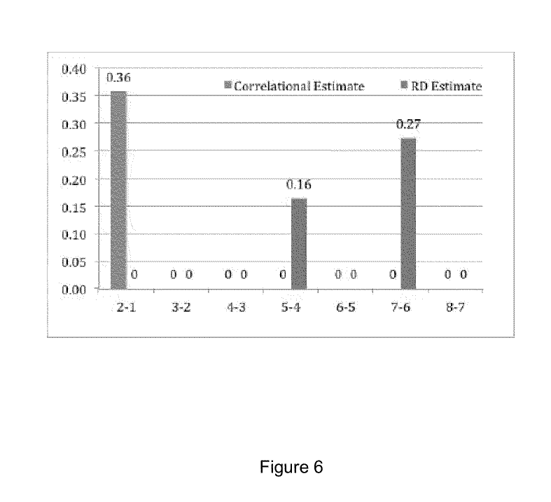

FIGS. 5 and 6 and Table 12 summarize the correlational and RD estimates for CTR for weekdays and weekends respectively. Comparing the correlational and RD estimates for click through rates (Table 12), we find that the correlational effect for position 1 for weekdays is positive, like in the case of the RD estimate, but is insignificant otherwise while the RD estimate is positive for positions 3 and 5 in addition. As in the case of most of the effects, the correlational effect for position 1 is lower than the RD estimate according to an embodiment of the present invention. For weekends, the correlational estimate for position 1 is positive and significant, while the RD estimate is insignificant. The correlational estimates for all other positions are insignificant, while we have marginal (at the 90% level) significant RD estimates for positions 4 and 6.

TABLE 12
Comparison of correlational RD estimates for weekday v. weekend: click through rates

| | Weekday (CTR %) | | | | Weekend (CTR %) | | | |
|---|---|---|---|---|---|---|---|---|
| | Correlational | | RD Estimates | | Correlational | | RD Estimates | |
| Position | Estimate | p-value | Estimate | p-value | Estimate | p-value | Estimate | p-value |
| 2 to 1 | 0.3703 | 0.0000 | 0.4395 | 0.0333 | 0.3568 | 0.0000 | 0.4658 | 0.1405 |
| 3 to 2 | 0.0285 | 0.3022 | 0.1091 | 0.1193 | −0.0182 | 0.6978 | −0.0066 | 0.9581 |
| 4 to 3 | −0.0015 | 0.9527 | 0.1283 | 0.0194 | −0.0403 | 0.3622 | 0.0423 | 0.6138 |
| 5 to 4 | 0.0316 | 0.2705 | 0.0256 | 0.6448 | 0.0003 | 0.5538 | 0.1637 | 0.0603 |
| 6 to 5 | 0.0104 | 0.7827 | 0.1448 | 0.0120 | −0.0078 | 0.5102 | 0.0407 | 0.6899 |
| 7 to 6 | 0.0905 | 0.1324 | 0.1056 | 0.2009 | −0.0208 | 0.8338 | 0.2730 | 0.0874 |
| 8 to 7 | −0.0081 | 0.9199 | −0.0238 | 0.8738 | −0.1010 | 0.4833 | 0.1123 | 0.5896 |

Once again, there is little agreement between the correlational and RD estimates according to an embodiment of the present invention, suggesting that the selection biases can lead to very misleading correlational estimates. We find a similar picture for sales orders, as reported in Table 13.

TABLE 13
Comparison of correlational RD estimates for weekday v. weekend: number of sales

| | Weekday (orders) | | | | Weekend (orders) | | | |
|---|---|---|---|---|---|---|---|---|
| | Correlational | | RD Estimates | | Correlational | | RD Estimates | |
| Position | Estimate | p-value | Estimate | p-value | Estimate | p-value | Estimate | p-value |
| 2 to 1 | 0.0017 | 0.0022 | −0.0004 | 0.8460 | 0.0005 | 0.6261 | 0.0027 | 0.3106 |
| 3 to 2 | −2.39e−4 | 0.5195 | 0.0006 | 0.4377 | 7.72e−4 | 0.2548 | 0.0002 | 0.8887 |
| 4 to 3 | 0.0002 | 0.5634 | −0.0004 | 0.5516 | −0.0003 | 0.6637 | −0.0006 | 0.7112 |
| 5 to 4 | 0.0004 | 0.3740 | 0.0002 | 0.7729 | 0.0003 | 0.7177 | 0.0033 | 0.0594 |
| 6 to 5 | 7.44e-6 | 0.9895 | 0.0008 | 0.1029 | 0.0002 | 0.8523 | 0.0053 | 0.0454 |

Advertiser-Specific Effects

In an embodiment of the present invention, we next examine if the position effects vary across advertisers. This can be an important question to study since some studies on position auctions assume that position effects (for example the ratio of click through rates across positions) are independent of advertiser. This assumption, however, has not been empirically tested until now.

We restrict our analysis to a set of keywords that are common across advertisers (else we would confound advertiser-specific effects with keyword-specific effects due to variation in the set of keywords across advertisers). This restriction allows us to compare only three of the four advertisers we have data for and to look at click through rates as the dependent variable, since there is not enough data for analysis for the fourth advertiser or for sales orders as the dependent variable. Also, we are only able to conduct the analysis for the first three positions in this embodiment. Table 14 reports these results.

TABLE 14
Firm-specific position effects for click through rates - RD estimates

| | Firm 1 (CTR %) | | | Firm 2 (CTR %) | | | Firm 3 (CTR %) | | |
|---|---|---|---|---|---|---|---|---|---|
| Position | Baseline | Estimate | p-value | Baseline | Estimate | p-value | Baseline | Estimate | p-value |
| 2 to 1 | 1.4026 | 0.3316 | 0.0806 | 1.1872 | 0.4106 | 0.0872 | 1.6274 | 0.8598 | 0.5116 |
| 3 to 2 | 0.9569 | 0.6016 | 0.2930 | 0.9335 | −0.0026 | 0.9921 | 0.6395 | −0.0252 | 0.9517 |
| 4 to 3 | 1.0147 | 0.5764 | 0.0734 | 0.7996 | 0.2001 | 0.0884 | 0.7656 | 0.1103 | 0.7704 |

We find that advertisers 1 and 2 have significant position effects (at the 90% significance level) for moving from position 2 to 1 and 4 to 3 respectively. Advertiser 3, however, has no significant effects at all. It is interesting to note that advertiser 3 is the largest and most well known of the three firms, with advertisers 1 and 2 of roughly similar size. This has significant implications for search advertising strategies for large, well-known advertisers vs. smaller, lesser known advertisers. While it is hard to make the causal connection between size of firm and the nature of the position effects, the important result is that the assumption of position effects independent of advertiser is not supported in our empirical application.

Profitability Analysis

An important question facing advertisers can be whether they are bidding optimally or not. The theoretical literature on position auctions largely suggests that firms should bid their valuations, since the auction design results in outcomes that are very close to those from a second price auction. Such a conclusion, however, does not take into account the nature of the dependence of outcomes such as clicks and purchases on the advertiser's position in the search advertising results. The underlying assumption is that a firm is best off at the highest position it can win.

This may not necessarily be true as we can see from the results of our analysis according to an embodiment of the present invention where higher positions may not result in higher clicks or sales. When clicks increase at a higher position, costs increase, both because of a higher cost per click and higher click through rates. If sales do not increase, the profitability of advertising at the higher position is strictly lower. When sales increase, it is ambiguous whether the firm is better off at the higher position or not, since it depends on the magnitude of increase in sales relative to the increased costs. When neither clicks nor sales increase, the firm is again typically worse off to the extent that the higher position entails a higher cost per click.

We conducted a set of simulations to attempt to evaluate the optimality of the bidding strategies of the firms in our dataset. Each simulation corresponds to a particular pair of adjacent positions. Consider all observations in position 2. The question we ask is whether the advertisers in these observations would have been better off being in position 1 or not. To answer this question, we use the RD estimates of the position effect according to an embodiment of the present invention in order to find the clicks and orders for each observation in position 2 were it to be in position 1.

We assume that the contribution margin for each observation that has positive orders, which we observe in the data, are unchanged. To account for the increased cost per click in position 1, we take advantage of the second-price nature of the auction and use the bid information available in the data. We assume that the cost per click in position 1 is equal to the bid of the advertiser in position 2. For each observation, we compute the change in costs for moving from position 2 to position 1, by accounting for the increased cost per click and changes in the number of clicks. We also compute the change in contribution margin, accounting for the changes in the number of orders. We then have an estimate of difference in profitability in advertising at position 2 vs. position 1. The standard error for this estimate is computed using a bootstrap procedure, which involves conducting this entire analysis with repeated random samples from the data. We repeat this analysis for other positions.

Table 15 presents the results of this analysis according to an embodiment of the present invention. In this table, we report for each position the baseline profits, reflecting the observations in the lower position. Using the procedure outlined above, we compute the change in profits when moving from the lower to the higher position, and report the percentage change in profits. On average, we find that the profit change is negative in moving from the lower to higher position, suggesting that firms are on average not underbidding. We computed not just the point estimate of the profit change, but also its standard errors. For an overwhelming majority of observations, the move from the lower position to the higher position reduces profitability. This is a consequence of sales orders not necessarily increasing with position, except from position 6 to 5, while clicks either increase or do not change significantly. However, it is interesting to note that even in the case of the move from position 6 to 5, where sales orders increase, profits increase only for a relatively small proportion of observations, and decrease for a majority of observations. This suggests that the increase in sales orders is not sufficiently large to offset the increase in costs associated in moving up a position.

TABLE 15
Profitability analysis

| | | | | | % Positive & | % Negative | Breakeven | |
|---|---|---|---|---|---|---|---|---|
| | Baseline Profits ($) | | Profit Change (%) | | Significant | & Significant | additional orders | |
| Position | Mean | Std. Dev. | Mean | Std. Dev. | Observations | Observations | Mean | Std. Dev. |
| 2 to 1 | 50.2541 | 125.8031 | −12.3109 | 19.6710 | 1.92% | 79.83% | 0.1168 | 0.2726 |
| 3 to 2 | 44.2031 | 99.6299 | −8.1568 | 17.4220 | 5.39% | 69.30% | 0.0892 | 0.3279 |
| 4 to 3 | 38.0052 | 73.8778 | −6.7229 | 16.4904 | 5.37% | 77.78% | 0.0732 | 0.2083 |
| 5 to 4 | 33.8282 | 67.0412 | −3.8196 | 11.9217 | 4.77% | 40.19% | 0.0511 | 0.1112 |
| 6 to 5 | 24.6485 | 55.2849 | −2.4467 | 5.4405 | 15.38% | 42.30% | 0.0343 | 0.0436 |

The analysis so far has focused on profitability in a short run sense since the dataset tracks only the first order associated with a click through from a search advertisement. Advertisers, however, may be interested in longer-run outcomes, with the purchase by the consumer potentially leading to repeat purchases in the future. It may be possible that it is unprofitable to move from the lower position to the next higher position in a short run sense but still optimal for the firm from a long run sense. While we do not have observations on repeat purchase in the data and cannot therefore conduct a direct analysis of whether it would make sense for firms to bid to be in higher positions, we indirectly attempt to answer this question by asking how many additional orders are necessary to make it worthwhile for the firm to move to the higher position. We can do this according to an embodiment of the present invention because we have an estimate of the difference in profits in moving from the lower position to the higher position. We also know the contributions margin for each order. We can compute how many additional identical orders (in a present discounted value sense) would be necessary to make up for this difference in profits between the positions. We once again compute standard errors for these estimates using a bootstrap procedure.

We report these breakeven additional orders in Table 15 as well. Note that we only report the number of additional orders required for breakeven for cases where it is less profitable to be in the higher position than in the lower position. It is interesting to see that these numbers are very small across all the positions. The highest number is for the move from position 2 to position 1. For just under 80% of observations, it was less profitable in a short run sense for the advertisers to move to position 1. But the minimum additional orders required in the future for it to be more profitable to move to position 1 is quite small, at 0.1168. If every 100 orders generate 11.68 orders in the future with similar value, it would be more profitable for the firm to move to position 1. There is of course a high degree of variance in these breakeven estimates. In all of these cases, the estimate of the breakeven number of orders was statistically significant.

Interestingly, the breakeven number of additional orders required for making the move upwards by a position profitable in the long run is much lower for lower positions. At position 6, for instance, it would take only 0.0343 additional orders per order to make it profitable for the advertiser to move to position 5. The numbers for other positions lie between these two extremes. These numbers suggest that while advertisers are better off remaining in their current positions if they are thinking about short-run profitability, it may make sense for them to bid to be in the next higher position, as long as they expect orders in the future exceeding the breakeven levels reported here. Since these numbers appear small in general, it is possible that firms are not taking a long-term view while formulating their bidding strategies.

While we do not have future orders in our data, we were provided with some information on the number of future orders that the advertisers in our dataset might find acceptable. It was reported to be in the range of 0.2 to 0.3 within a one year period. For the move from position 2 to position 1, we find that 65.54% of observations have breakeven values of additional orders than are below 0.2, and 72.75% have breakeven values below 0.3. If we take these numbers provided by the firm as a benchmark, the advertiser would benefit in a long-term sense by moving to position 1 in a majority of cases, even though it is profitable in the short-term sense to stay in the lower position. We believe this is an important finding of this disclosure.

Robustness

We conducted a local linear regression to obtain our RD estimates according to an embodiment of the present invention, but find that the results are very close to those obtained using our estimator described earlier. We also investigate the choice of bandwidth, which is an important aspect of the RD design. We chose an arbitrary bandwidth of 5% of a standard deviation of the score. Bandwidth choice entails a tradeoff between bias and efficiency. A large bandwidth will typically lead to more biased estimates but with better efficiency (lower standard errors), while a smaller bandwidth will have the opposite effect.

We check for the robustness of our results according to an embodiment of the present invention to bandwidth choice by repeating the analysis for the pooled results with a lower bandwidth of 2.5% of a standard deviation. The comparisons of our results (at 5% bandwidth) with those at the lower bandwidth are reported in Tables 16 and 17. These comparisons illustrate the bias vs. efficiency tradeoffs described above. The main point, however, is that the results are largely similar with the lower bandwidth, giving us confidence in our estimates. We tested other bandwidths including larger ones than 5% of a standard deviation and find that our results are robust to bandwidth choice.

TABLE 16
Robustness check - bandwidth selection (CTR)

| | Bandwidth = 0.05σ² (CTR %) | | | Bandwidth = 0.025σ² (CTR %) | | |
|---|---|---|---|---|---|---|
| Posi- | Base- | Esti- | p- | Base- | Esti- | p- |
| tion | line | mate | value | line | mate | value |
| 2 to 1 | 2.3404 | 0.4415 | 0.0106 | 2.3792 | 0.3108 | 0.1362 |
| 3 to 2 | 1.2802 | 0.0774 | 0.2059 | 1.3240 | 0.0974 | 0.2625 |
| 4 to 3 | 1.0304 | 0.1143 | 0.0142 | 0.9811 | 0.1371 | 0.0339 |
| 5 to 4 | 0.8620 | 0.0589 | 0.2078 | 0.9428 | 0.0404 | 0.5503 |
| 6 to 5 | 0.7635 | 0.1135 | 0.0236 | 0.7573 | 0.0622 | 0.3011 |
| 7 to 6 | 0.7161 | 0.1521 | 0.0378 | 0.5287 | 0.1837 | 0.4750 |
| 8 to 7 | 0.4913 | −0.0082 | 0.9459 | 0.4750 | 0.0794 | 0.6576 |

TABLE 17
Robustness check - bandwidth selection (orders)

| | Bandwidth = 0.05σ² (Orders) | | | Bandwidth = 0.025σ² (Orders) | | |
|---|---|---|---|---|---|---|
| Posi- | Base- | Esti- | p- | Base- | Esti- | p- |
| tion | line | mate | value | line | mate | value |
| 2 to 1 | 0.0044 | 0.0005 | 0.7783 | 0.0057 | −0.0015 | 0.5145 |
| 3 to 2 | 0.0026 | 0.0005 | 0.4993 | 0.0024 | −0.0003 | 0.7732 |
| 4 to 3 | 0.0033 | −0.0005 | 0.4137 | 0.0032 | −0.0008 | 0.3449 |
| 5 to 4 | 0.0016 | 0.0009 | 0.2385 | 0.0026 | 0.0006 | 0.6521 |
| 6 to 5 | 0.0009 | 0.0019 | 0.0108 | 0.0000 | 0.0012 | 0.1317 |

Embodiments of the present invention address the important issue of the causal effect of position in search advertising on outcomes such as website visits and sales. An embodiment of the present invention includes a regression discontinuity-based algorithm for uncovering causal effects in this context. The importance of this approach is particularly high in this context due to the difficulty of experimentation and the infeasibility of other approaches such as instrumental variable methods.

Embodiments of the present invention disclose that there are significant position effects, and that these would be understated by correlational analyses. The selection biases in this context happen to be negative and hence wipe out the causal position effects. Further, embodiments of the present invention disclose that the position effects are of great economic significance, increasing the click through rates by about a fifth in positions where they are significant. We find important differences in these effects between broad and exact match keywords, and that exact match delivers significantly higher click through rates. Exact match keywords have significant effects only at the very top position, while broad match keywords have significant effects only lower down. We find important weekend effects in this context. Position effects are weaker on the weekend and this result is consistent with the idea that consumers' search costs are lower during the weekends. We also find that position effects vary across advertisers, with implications for theoretical research in the area.

We next conducted a simulation analysis according to an embodiment of the present invention to assess if advertisers would benefit by moving up a position relative to their current positions. We find that in a majority of cases, profits would reduce by moving up a position, suggesting that firms are better off remaining at their current positions. Even in the move from position 6 to position 5, where sales orders increase, the increase in sales orders offsets the increased cost only in about 15% of the cases, with profits reducing in about 40% of the cases. However, this analysis, which is based on short-term profits ignores the potential of future orders. We find that the breakeven number of additional orders required to make it profitable for the firm to move up a position is relatively small, ranging from about 0.03 future orders per order in the case of the move from position 6 to 5, to about 0.11 future orders per order in the case of the move from position 2 to position 1. This suggests that while firms may be largely better off at their current positions in a short-term sense, it may make sense for them to bid to be in higher positions in a long-run sense. This, in our view, is an important new finding for this industry.

The results of embodiments of the present invention may be of interest to managers who are setting firms' online advertising strategies. The methodological innovation could be of interest to search engines as well, who might be interested in viable alternatives to experimentation, which tends to be difficult and expensive in this context, in addition to being subject to contractual limitations.

Regression Discontinuity with Estimated Score

We now turn to extending the scope of Regression Discontinuity to contexts where the score or the threshold are not fully observed. A method according to an embodiment of the invention involves estimating the unobserved scores using a first stage approximation, which involves fitting a binary choice model for treatment as a function of observed score components or other exogenous covariates. In a second stage of the described embodiment, the outcomes for individuals with estimated score just above the threshold are compared with those just below the threshold to obtain the treatment effect, as in a standard RD approach.

Among other things, we will discuss the conditions under which Regression Discontinuity with Estimated Score (RDES), according to an embodiment of the present invention, uncovers a valid treatment effect. We conducted a set of Monte Carlo simulations to demonstrate that RDES according to an embodiment of the present invention is able to recover valid estimates and is able to explore the conditions required to estimate the treatment effect. We validated the methodology according to an embodiment of the present invention in two settings. The first is a casino direct marketing setting where the casino uses scores to decide on the treatment (offers mailed to consumers). In our dataset the exact scores are observed. The second empirical setting of the described embodiment is the estimation of position effects in search engine advertising, where advertisers are selected by the search engine for the treatment (position) in an auction, but the threshold is not observed and only some components of the underlying score are observed. In both settings we are able to obtain standard RD estimates of the treatment effects according to an embodiment of the present invention and compare them to estimates obtained using RDES according to an embodiment of the present invention, assuming that the score is not fully observed.

Introduction

In many marketing contexts, a treatment is administered based on whether an underlying continuous score variable crosses a threshold. For instance, pharmaceutical firms might plan to make detailing calls on physicians only if their prescription volume exceeds a certain amount. Direct marketing firms might send catalogs or promotional offers to only those consumers who satisfy their “recency, frequency and monetary value” (RFM) cutoffs. Online retailers might provide certain offers only to customers who visited their web site within a certain number of days before the day the offers are sent. Search engines may select advertisers for a position only when their AdRank exceeds the AdRank of the next highest advertiser. The untreated group (e.g., physicians who do not receive detailing calls, consumers who do not receive catalogs or offers etc., search engine advertisers that do not get selected for the position and are placed in the next highest position) in such contexts are typically not a valid control for the treated group since the underlying propensity for the outcome variable of interest is likely to be different for the treated and untreated groups. For instance, physicians who receive detailing calls are likely to be heavier prescribers for the focal drug than those who do not receive any calls since calls are typically based on a related measure of prescription volumes in the category. Consumers who receive promotional offers are more likely to purchase the product than those who did not, even in the absence of the offer, given that promotions are based on purchase or visitation history. Search engine advertisers who are selected for a higher position might observe a higher click through rate in that position that might be a combination of intrinsic higher click through rate and the incremental effects of the higher position.

Many such contexts lend themselves to a regression discontinuity (RD) design, which measures the causal treatment effect by comparing groups of observations with and without treatment within a very small neighborhood of the threshold. For instance, doctors who are just above the threshold for detailing are compared to those just below, with the latter forming a valid control group for the former.

In search engine advertising, advertisers are selected based on their bid and quality score versus the bid and quality score of competitors. Advertisers observe their own bid and quality score, but do not observe the bid or the quality score of the competitor and hence have incomplete information on the underlying score used for selection.

In an embodiment of the present invention, we extend regression discontinuity to such contexts where the score or the threshold are unobserved or only partially observed. The method according to an embodiment of the present invention involves two stages. In the first stage, we fit a choice model (such as a binary logit model) with the treatment variable as the dependent variable and observed score components and potentially other observed variables as covariates. A choice model involves an underlying latent variable with the outcome based on whether this latent variable crosses a threshold. In our case, the latent variable is the score variable. Using the first stage estimates, we can find estimated values of the score variable for each observation according to an embodiment of the present invention. We then apply a regression discontinuity design in the second stage, using the estimated score values as a proxy for the unobserved score. In an embodiment, since there is a threshold of zero for the latent variable in a choice model, we do not need to observe the threshold for treatment in order to apply this methodology.

In the present disclosure, we show that Regression Discontinuity with Estimated Score (RDES) according to an embodiment of the present invention provides valid local average treatment effects under certain regularity conditions. This allows us to extend RD to a variety of contexts where standard RD may be infeasible.

Using a set of Monte Carlo simulations, we establish the set of conditions required for RDES to recover the treatment effect according to an embodiment of the present invention. We then validate our methodology in real-world contexts. The first application is in the context of promotional offers sent to consumers of a casino based on whether their past gambling volumes exceeded a known threshold. We apply a method according to an embodiment of the present invention to this problem, proceeding as if the score and threshold were unobserved. We are then able to compare our estimates to those obtained using standard RD according to an embodiment of the present invention, which is feasible in the context given that the score and threshold are observed in the data.

The second application is in the context of advertising on the Google search engine, where our focus is on uncovering the causal effect of the position of the advertisement on sales. On Google, an advertiser is selected for a position if their score (AdRank) exceeds that of a competitor. AdRank is the product of the advertiser's bid, and a quality score for the advertisement, which is assigned by Google. So position is determined by both the firm's actions and competitors' actions.

A simple mean comparison of outcomes across positions to measure effects of position on outcomes such as click through rates and purchase rates could be misleading because it is confounded with the firm's and competitors' actions and their potentially different underlying click through and purchase rates. An RD design according to an embodiment of the present invention could potentially uncover the treatment effect of position, comparing observations where advertisers win the bid for a position by a small margin (i.e. their AdRank is just a little bit above that of their competitor) to observations where they lose the bid by a small margin.

While advertisers observe their own AdRank, they do not observe their competitors' AdRank, and hence, an exact RD design can be infeasible. We apply our proposed RDES approach according to an embodiment to this context using a dataset for a leading online retailer. A unique feature of this dataset is that we observe the history of advertising and sales not just for the focal firm but also for its major competitors since the firm acquired these competitors. The AdRank for the firm and its competitors are observed, and we can apply a standard RD design according to an embodiment of the present invention for this case. We are able to validate the estimates of the RDES method according to an embodiment of the present invention with the standard RD estimates.

RD with Estimated Score

Consider the situation where the score variable or the cutoff are unobserved to the analyst. In such a case, we would not be able to apply the standard RD approach to measure the treatment effect since we would not be able to directly find the limiting values of the outcome and treatment variables. Consider cases where it is known that there is an underlying score variable that is used by the firm, and while the score is unobserved, components of the score and potentially other covariates that explain treatment are observed. For instance, in the direct marketing example given earlier, suppose we know that the score is a combination of Recency, Frequency, and Monetary Value. If the analyst only observes Recency, Frequency, and Monetary Value, neither the score nor the threshold is observed. But components of the score are observed.

In an embodiment of the present invention, a two-stage estimation procedure is used to obtain valid treatment effects. In the first stage, we estimate a binary choice model with the treatment as the dependent variable and the observed score components or other covariates as independent variables. Like in the case of RD, a binary choice model assumes that the dependent variable—the treatment in this case—takes the value 1 when an underlying latent variable crosses zero and takes the value 0 otherwise. This latent variable acts like the score variable in an RD design. We use the estimates of the choice model in an embodiment of the present invention to find the fitted value of the latent variable, which we call the estimated score. In the second stage according to an embodiment of the present invention, we estimate the treatment effect by comparing outcomes for observations with estimated score just above and just below zero since a binary choice model has a natural threshold of zero for the latent variable.

Formally, let the outcome variable of interest be denoted by y, and the score variable be denoted by \tilde{z}. Let the treatment x be binary such that x=1 when \tilde{z}> z̅ and x=0 when \tilde{z}≦ z̅. Here, z̅ is the threshold above which there is treatment. If the score \tilde{z} is observed, implementing an RD design would be straightforward. With \tilde{z} unobserved, let us z assume that there is a vector of observed covariates \tilde{r}, such that

\tilde{z}=f(\tilde{r},ε; θ̅ (3)

where ε is an unobservable variable and θ̅ is a vector of parameters. Let the unobservables be additively separable and uncorrelated with r̅ and let f(.) be linear in the parameters, i.e.,

\tilde{z}=\tilde{r}\tilde{θ}+ε (4)

Further, if we define

z≡\hat{z}− z̅, r≡(1 r̅) and θ≡(\tilde{z}\tilde{θ}′)′,

we have

z=rθ+ε (5)

with treatment taking place if this transformed score z crosses the threshold of 0. This situation is akin to that of a choice model where there is an unobserved latent variable (such as z) and an observed binary dependent variable (such as the treatment variable x) that takes the value 1 if z>0 and 0 otherwise. We can estimate a discrete choice model, for instance a logit model, where the dependent variable is the treatment variable x and r as the vector of exogenous covariates. This gives us an estimate of θ (denoted by \hat{θ}), from which we can estimate the value Of the score, say \hat{z}, given by z

\hat{z}=r\hat{θ} (6)

We then use this estimated value of the score to construct an RD design, comparing observations with estimated score just above and just below 0. We now show that this is a valid RD design under certain regularity conditions.

Proposition 1. (Continuity Condition) The score z is continuous at \hat{z}=0, when the number of observations in the first stage regression N→∞, the first stage estimates are consistent and there is at least one continuous covariate. Under these conditions,

$${Lim}_{λ -> 0} 𝔼 [ z \vert \hat{z} = λ ] = {Lim}_{λ -> 0} 𝔼 [ z \vert \hat{z} = - λ ] , λ > 0$$

Proof. Let r₁ be a value of the covariate such that r₁\hat{θ}=λ and r₂ be a value such that r₂\hat{θ}=−λ. With the condition of at least one continuous covariate, we can find r₁ and r₂ for an arbitrary value of λ.

z=r₁θ+ε₁, when \hat{z}=λ (7)

z=r₂θ+ε₂, when \hat{z}=−λ (8)

Thus,

$$\begin{matrix}{Lim}_{λ -> 0} 𝔼 [ z \vert \hat{z} = λ ] = {Lim}_{{r}_{1} \hat{θ} -> 0} 𝔼 [ {r}_{1} θ + {ɛ}_{1} ] \\ = {Lim}_{{r}_{1} \hat{θ} -> 0} 𝔼 [ {r}_{1} \hat{θ} + {r}_{1} ( θ– \hat{θ} ) + {ɛ}_{1} ] \\ = {Lim}_{{r}_{1} \hat{θ} -> 0} 𝔼 [ {r}_{1} \hat{θ} ] + {Lim}_{{r}_{1} \hat{θ} -> 0} 𝔼 [ {r}_{1} ( θ - \tilde{θ} ) ] + {Lim}_{{r}_{1} \hat{θ} -> 0} 𝔼 [ {ɛ}_{1} ]\end{matrix}$$

$${Lim}_{{r}_{1} \hat{θ} -> 0} 𝔼 [ {r}_{1} \hat{θ} ] = 0$$

and given that ε is a mean zero random variable orthogonal to the covariate,

$${Lim}_{{r}_{1} \hat{θ} -> 0} 𝔼 [ {ɛ}_{1} ] = 0.$$

### Hence,

$$\begin{matrix}{Lim}_{λ -> 0} 𝔼 [ z \vert \hat{z} = λ ] = {Lim}_{{r}_{1} \hat{θ} -> 0} 𝔼 [ {r}_{1} ( θ - \hat{θ} ) ] \\ = {Lim}_{{r}_{1} \hat{θ} -> 0} 𝔼 [ {r}_{1} ] 𝔼 [ ( θ - \hat{θ} ) ] \\ = {Lim}_{{r}_{1} \hat{θ} -> 0} 𝔼 [ {r}_{1} ] {Lim}_{{r}_{1} \hat{θ} -> 0} 𝔼 [ ( θ - \hat{θ} ) ]\end{matrix} \qquad ( 10 )$$

where we make use of the fact that the limit of the product of two function is equal to the product of the limits of these functions.

[symbol] [(\hat{θ}−θ)] is the bias of the first stage estimates, and under the condition that the first stage gives us consistent estimates, this goes asymptotically to 0. Thus, as N→∞

$${Lim}_{λ -> 0} 𝔼 [ z \vert \hat{z} = λ ] = 0 \qquad ( 11 )$$

Similarly, we can show that

$${Lim}_{λ -> 0} 𝔼 [ z \vert \hat{z} = - λ ] = {Lim}_{{r}_{2} \hat{θ} -> 0} 𝔼 [ {r}_{2} ] {Lim}_{{r}_{2} \hat{θ} -> 0} 𝔼 [ ( θ - \hat{θ} ) ] = 0 \qquad ( 12 )$$

This proves the continuity condition. Note that this continuity condition applies even in the case that r1 and r2 are not unique, i.e. multiple values of these vectors are consistent with r₁\hat{θ}=λ and r₂\hat{θ}=−λ respectively since the limits are the same for all values of r₁ and r₂.

Proposition 2. (Discontinuity Condition) The treatment x is discontinuous at \hat{z}=0, when the number of observations in the first stage regression, N→∞ and the first stage estimates are consistent. Under these conditions,

$${Lim}_{λ -> 0} 𝔼 [ x \vert \hat{z} = λ ] \neq {Lim}_{λ -> 0} 𝔼 [ x \vert \hat{z} = - λ ] , λ > 0$$

Proof. Since x is a discrete variable taking the values 0 or 1,

[symbol]

[x|\hat{z}=λ]=Pr[x=1|\hat{z}=λ] (13)

Defining r=r₁ such that r₁\hat{θ}=λ and noting that x=1 if z>0 and that at r=r₁, z=r₁θ+ε₁, the left hand side of the discontinuity condition is

$$\begin{matrix}{Lim}_{λ -> 0} 𝔼 [ x \vert \hat{z} = λ ] = {Lim}_{{r}_{1} \hat{θ} -> 0} Pr [ {r}_{1} θ + {ɛ}_{1} > 0 ] \\ = {Lim}_{{r}_{1} \hat{θ} -> 0} Pr [ {ɛ}_{1} > - {r}_{1} θ ]\end{matrix} \qquad ( 14 )$$

The right hand side of the discontinuity condition is similarly given by

$${Lim}_{λ -> 0} 𝔼 [ x \vert \hat{z} = - λ ] = {Lim}_{{r}_{2} \hat{θ} -> 0} Pr [ {ɛ}_{2} > - {r}_{2} θ ] \qquad ( 15 )$$

The left and right hand sides of the discontinuity condition can be equal only if for arbitrarily small values of λ, the two probabilities in equations 14 and 15 are equal. This is only possible when

r₁θ=r₂θ (16)

As N→∞, \hat{θ}→θ. Hence, asymptotically, equations 16 and 17 cannot both be satisfied. The probabilities in equations 14 and 15 cannot be equal, proving the discontinuity condition.

Proposition 3. When Propositions 1 and 2 are satisfied, we can obtain valid treatment effect using

$$d = \frac{{Lim}_{λ -> 0} 𝔼 [ y \vert \hat{z} = λ ] - {Lim}_{λ -> 0} 𝔼 [ y \vert \hat{z} = - λ ]}{{Lim}_{λ -> 0} 𝔼 [ x \vert \hat{z} = λ ] - {Lim}_{λ -> 0} 𝔼 [ x \vert \hat{z} = - λ ]} = \frac{{y}^{+} - {y}^{-}}{{x}^{+} - {x}^{-}}$$

Proof. This simply follows from applying the conditions of Hahn, Todd, and van der Klaauw (2001). The continuity conditions are satisfied when the score is continuous at the threshold, which we have proved in Proposition 1. Thus, d obtains the valid treatment effects asymptotically when we have a set of exogenous covariates that obtain consistent estimates of \hat{θ} in the first stage of our method.

The foregoing discussion establishes the conditions under which valid treatment effects can be obtained using a Regression Discontinuity design even when the score is only partially observed and when the threshold is unobserved according to an embodiment of the present invention. The main conditions are that we have many observations for the first stage estimation since the validity of the second stage estimates depend on asymptotic results. Second, we need the score function to be linear in the observed and unobserved components in order to satisfy the continuity condition in Proposition 1. Third, we require at least some of the observed score components or other covariates to be continuous. More generally, we need consistency of the first stage estimates in order to get a valid RD design, and this requires that the specification in the first stage model is robust to any endogeniety in the observed covariates used in the first stage. In practice, there are several situations where these conditions may be satisfied in marketing contexts.

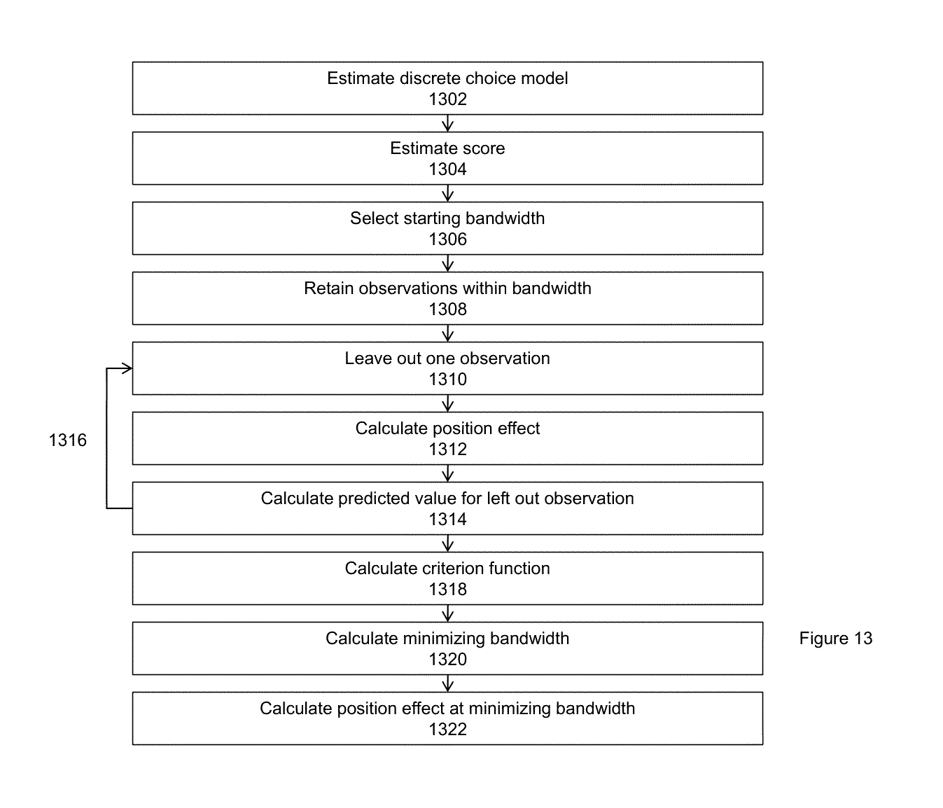

Shown in FIG. 13 is flow diagram of method steps for implementing Regression Discontinuity with Estimated Score according to another embodiment of the present invention. It should be noted that the described embodiments are illustrative and do not limit the present invention. For example, to the extent certain exemplary steps are described with reference to a particular search engine, such steps are to be understood as generally applicable to other search engines. It should further be noted that the method steps need not be implemented in the order described. Indeed, certain of the described steps do not depend from each other and can be interchanged. For example, as persons skilled in the art will understand, any system configured to implement the method steps, in any order, falls within the scope of the present invention.

It should be understood that the method of FIG. 13 is applicable to finding treatment effects in contexts other than position effects in search advertising. For example, the method of FIG. 13 is applicable to contexts where a treatment is based on an underlying continuous score which itself is unobserved but some components of the score or covariates that help explain treatment are observed.

As shown in FIG. 13 at step 1302, an estimate is determined for a discrete choice model for treatment as a function of observed score components and potentially other covariates. For example, one could estimate a binary probit model as outlined below

treatmentᵢ=1(Uᵢ>0)

Uᵢ=Zᵢω+ν,v˜N(0,1)

where U, is the transformed score—it is equal to the score when the threshold for treatment is 0, and is the difference between the score and the threshold when the latter is non-zero. Zᵢ is the set of observed score components and/or covariates and includes an intercept. The unobserved part of the score is represented by v, with its mean and variance fixed for identification purposes.

At step 1304, the estimated (e.g., fitted) value of the score is calculated. In an embodiment, this is calculated using the estimates \hat{ω} from the model. The estimated score is

Ûᵢ=Zᵢ\hat{ω}

At step 1306, a starting value for the bandwidth λ for the RD is selected. For example, 5% of the standard deviation of the score, which is ΔAdRank in our case.

At step 1308, observations with score within the bandwidth λ are retained: In an embodiment, the RD design compares observations for which 0<Ûᵢ<λ with those for which −λ<Ûᵢ<0. In an embodiment, observations are retained for which |Uᵢ|<λ. In an embodiment, the number of retained observations is N.

At step 1310, one observation is left out of the set of observations selected within the bandwidth. For example, in an embodiment, the n^{th} observation is left out.

At step 1312, a position effect is estimated. In an embodiment, we estimate the position effect local linear regression below for the set of N−1 observations, e.g., the observations within the bandwidth, but excluding the nth observation:

yᵢ=α+β·treatmentᵢ+γ·ΔÛᵢ+δ·Ûᵢ·treatmentᵢ+μ·Xᵢαεᵢ

Here, yᵢ is the outcome of interest, for instance the click through rate or sales. The treatment effect is given by β. The γ and δ terms respectively control for the systematic variation of the outcome with the score and how this potentially differs for treated and untreated observations. The term Xᵢ includes other controls, including potentially fixed effects. In another embodiment, this local linear regression can be substituted by a local non-linear regression including for higher instance higher order polynomial terms in ⁻Ûᵢ, and a non-uniform kernel, where the observations are given different weights based on how far the ⁻Ûᵢ, is from zero. The boundary properties of the local linear regression with a uniform kernel make it typically a good choice.

At step 1314, a computation is made of the predicted value ŷₙ of the outcome for the n^{th} observation that has been left out using the regression coefficients.

In an embodiment, steps 1310 through 1314 are repeated as shown by loop 1316 for all observations in set of N retained observations in step 1308.

At step 1318, a criterion function is calculated. In an embodiment, the criterion function is φ=Σₙ₌₁^{N} (yₙ−ŷₙ)².

At step 1320, the value of the bandwidth λ=λ* that minimizes φ, is found. In an embodiment, this is performed with an optimizer algorithm as known to those of ordinary skill in the art.

At step 1322, a position effect is determined at the value of λ=λ*. In an embodiment, its standard error is also determined using the non-parametric estimator outlined in step 1312. In an embodiment, the standard errors are also determined. In an embodiment, this is performed using a bootstrap, which involves drawing (with replacement) repeatedly from the data and estimating the treatment effect using the steps described above. The distribution of treatment effects obtained from these repeated estimation runs provides the bootstrap standard errors for the estimate.

It would also be useful at this stage to compare an embodiment of the present invention to the alternative of using an instrumental variables approach. If one can obtain valid instruments, which are correlated with treatment but uncorrelated with the errors in the treatment equation, one could find the two-stage least squares estimates for the treatment effect. At first glance, it may appear that the method according to an embodiment of the present invention is a special case of the IV approach. There are significant differences between the two. For example, the RDES estimator does not require that the observed covariates or score components be uncorrelated with the unobservables in the outcome equation. Indeed, one could make the case that the observed covariates might well be correlated with the observed score components. For instance, in a direct marketing context, an observed score component might be the frequency of purchases in a given time period in the past, which is likely to be correlated with unobserved factors affecting the outcome (say purchase from a catalog) such as a recurring discount. The frequency could not be credibly used as an instrument in the outcome equation. However, the RDES according to an embodiment of the present invention would be valid provided the other regularity conditions are met.

In general, many marketing contexts have treatment based on aspects of purchase history of the consumer. Such variables would be often hard to justify as valid instruments but could be credibly used in an RDES design according to an embodiment of the present invention. RDES designs, however, may require the exogeneity and continuity assumptions laid out in Propositions 1 and 2. In practice, these would be satisfied in many marketing contexts.

Another approach according to an embodiment is that of using matching estimators, which involve finding observations in the treated and untreated groups with similar observables that help explain treatment. The approach relies on the assumption that unobservables for the treated and control groups are the same for every value of the observables, or equivalently that the unobservables of the outcome equation and the selection equation are uncorrelated. This assumption may be difficult to justify under many contexts.

The RDES approach according to an embodiment of the present invention does not rely on such an assumption and hence can provide credible estimates in many contexts where matching estimators may be infeasible. A further modification of the matching estimator allows for the unobservables in the treatment equation to be correlated with those for the selection equation but relies on exclusion restrictions to set up estimators for the treatment effect. Once again, the exclusion restrictions may be difficult to obtain or justify in many contexts.

Monte Carlo Simulations

Above, we showed analytically that if the first stage estimates in the RDES approach according to an embodiment of the present invention are consistent, then the two conditions for a valid RD design, namely continuity of estimated score and discontinuity of treatment, both at the threshold are met. Here, we investigate how the magnitude of the error in the first stage estimates impacts the standard error of the second stage estimates of the treatment effects. There is no analytical expression for the second stage standard errors. We use a series of Monte Carlo simulations to investigate the impact. We also examine some potential mis-specifications in the first stage model. One type of mis-specification might occur when the observed components of the score are correlated with the error term and hence are endogeneous. A second type of mis-specification might occur when the distributional assumptions of the error term in the first stage model are mis-specified. The results of the Monte Carlo simulations demonstrate that the RDES approach according to an embodiment of the present invention recovers the true treatment effects very well under a variety of conditions.

In terms of the Monte Carlo design, we first simulate the observed score components, denoted by vector \tilde{r} and the unobserved component ε, and generate the score variable \tilde{z} for each observation. We then apply the treatment rule using a threshold rule on the score with treatment set to 1 when the score crosses the threshold z̅, and 0 otherwise. We also simulate the outcome, as a function of the score and the treatment using assumed parameter values including a random shock in the outcome. We then obtain treatment effects in two ways, one using an RD design (since we observe the true score in the simulation) and then using an RDES approach according to an embodiment of the present invention. Since there is no analytical expression for the standard errors of the treatment effects for the RDES estimator, we obtain the standard errors using a bootstrap procedure. This involves repeatedly sampling from the data, obtaining our two-stage estimates as proposed and finding the standard deviations of the set of estimates. For each simulation, we use a total of 100000 observations, and for the standard RD and the two-stage RD we choose a bandwidth that is 0.05 times the standard deviation of the score or predicted score respectively.

The true score function is given by

\tilde{z}=\tilde{r}\tilde{θ}αε (18)

In this case, \tilde{r} has one dimension, drawn from a Uniform [−1, 1] distribution. The true value of \tilde{θ} is set to 1. The error ε is assumed to be drawn from a normal distribution with mean 0 and variance σ_{ε}². We vary σ_{ε}_{^{v}}² to vary the amount of information in the observed vs. unobserved variables. When σ_{ε}_{^{v}}² is high, the amount of information in the observed score component \tilde{r} is relatively low, and this would tend to increase the standard error of the two-stage RD estimates. The treatment x is set to the value 1 if \tilde{z} is greater than \tilde{z}=1, and is set to 0 otherwise.

Unless otherwise stated, we use a binary probit model in the first stage regression to find an estimate of θ and therefore of z. The first stage estimating equation is

z=rθ+η˜N(0,1) (19)

x=1(z>0) (20)

Note that r includes an intercept and is defined as

r≡(1\tilde{r}) and θ≡(1\tilde{θ}′)′.

This gives us an estimate \hat{θ}, which is then used to obtain the estimated score \hat{z}=r\hat{θ}. This estimated score is then used to implement an RD design to obtain the estimate of the treatment effect d.

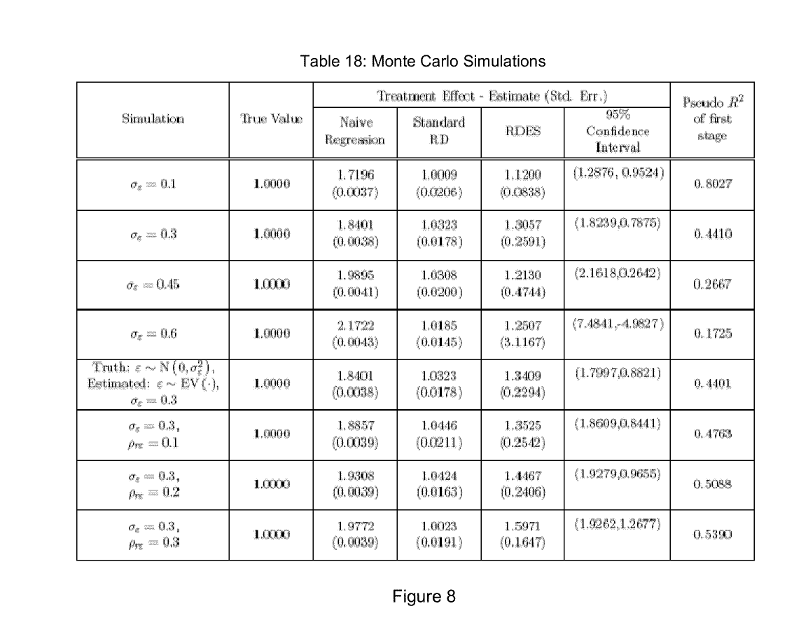

Table 18 (shown in FIG. 8) reports the estimates of the Monte Carlo simulations. While we ran a large number of Monte Carlo simulations, we report the estimates of one simulation each for purposes of illustration. The first four rows of the table report the results of the simulation based on the underlying score generated by equation 18 and the score estimated using the first stage regression specified in equation 19.

First, a regression of the treatment variable on the outcome gives highly biased and highly significant estimates, which reflect the fact that the outcome is a function not just of the treatment but of the score itself as well. For example, in the first row the true value of the treatment effect is 1.0 whereas the value of the naive regression estimate is 1.7196, a significant bias. The 95% confidence interval values for the naive estimator are 1.727 and 1.7122. Note that this interval does not contain the true value. Rows two to four show a similar situation where the naive regression estimates are highly biased and highly significant and the 95% interval does not contain the true value.

This shows the basic identification problem that RD tries to address. As seen in the table, both the standard RD and two-stage RD are able to recover the true value quite well in all the simulations. In the first three rows of the table, we report the simulations with different levels of information in the observed score component. The second row represents the baseline simulation, with a standard deviation of the error at 0.3 (generating draws for the error between approximately −1 and 1). In this case, the variation in the error approximately equals the variation in the observed variable. The observed and unobserved variables roughly explain about half the treatment effect. The simulations in the first and third row decrease and increase the variance in the unobservable respectively, keeping the observed variable unchanged.

The pseudo-R² reported in the table reflects this change. We see that the first row, which corresponds to the case where the variation in the observed variable explains more of the variation in treatment than the unobservable, the standard errors of the treatment effect estimated using two-stage RD are much lower than in the second row. The 95% interval for the RDES estimates according to an embodiment of the present invention contains the true value. In the third row, the standard errors go up significantly, where the unobservables explain much of the variation in the treatment effect. The pseudo-R² of the first stage regression drops to 0.2667. Even in this case, RDES according to an embodiment of the present invention provides a significant estimate of the treatment effect with the correct signs and a bias that is much smaller than the bias in the naive regression estimates. The 95% interval of the RDES estimates contains the true value. The fourth row of the table presents an extremely noisy situation where the unobservables explain almost three quarters of the variance in the score. In this case the pseudo-R² of the first stage regression drops to 0.1725 and the estimated scores are quite noisy. Not surprisingly the noise in the first stage estimates transfers to the estimates of the treatment effects which are not statistically significant. The 95% interval contains the true value, but is quite large.

We next turn our attention to a mis-specification of the first stage model. In the fifth row of the table, we report a simulation where the true score function has normal errors as in equation 18, but we estimate a first stage equation assuming errors of the extreme value-type 1 distribution. We estimate a logit model in the first stage. We see that we are able to recover the treatment effect with the 95% interval containing the true value even in this case. We note that the RDES estimate and the confidence intervals are not that different from row 2. Finally we examine another type of mis-specification where the observed value are correlated with the error term and hence are endogeneous. The sixth row of the table shows the results for a situation where the correlation ρrε is quite mild with a value of 0.1. Even in this case, the RDES estimates according to an embodiment of the present invention have the correct sign and the 95% interval contain the true value. However consistent with intuition, the RDES estimates are more biased, but the standard error does not change much. The last two rows of the table show situations where the endogeneity gets more severe with ρrε values of 0.2 and 0.3 respectively. As we would expect the RDES estimates get more biased but are still significant, recover the true parameter values with the correct signs and the 95% intervals contain the true value.

The Monte Carlo simulations establish that the RDES method according to an embodiment of the present invention recovers the true treatment effect. We find that it can recover significant estimates when the level of information in the observed score component is reasonable. For instance, we show in the baseline case that with equal degree of variation in the observed and unobserved variables, the procedure is able to recover the treatment effect with a high degree of statistical significance. When the treatment effect is largely explained by the unobservable, as in one of the simulations we have shown, the treatment effect estimated by an embodiment of the present invention is insignificant. The degree to which the observed variables explain treatment can be found using measures of fit in the first stage. For instance, in the probit regressions we have shown, one could assess the degree of fit using pseudo-R² estimates. We have also shown through these simulations that we are able to recover the parameters quite well even if the true distribution of the unobservable in the score function is different from the one we use in estimation. Finally our simulations show that even when the first stage model is mis-specified due to endogeniety, the RDES estimate have the right sign and the 95% intervals recover the true value. These Monte Carlo simulations establish the validity of embodiments of the present invention in a variety of situations.

Applications

We have demonstrated using simulations that our methodology according to an embodiment of the present invention is able to recover treatment effects when the true score is not known but only components of the score are known. We further validate embodiments of the present invention by using two real-world applications, in both of which the score is observed. We can estimate the treatment effect using a standard RD design according to an embodiment of the present invention. We then proceed as if the true score were unobserved and estimate the treatment effect using our RDES according to an embodiment of the present invention. We are able to compare the two sets of estimates and verify RDES is able to recover true treatment effects in a real world context.

Casino Direct Marketing Application

The first application is about direct marketing in the casino industry where consumers are enrolled in a loyalty program for the firm. Periodically, the firm sends promotional offers to their customers to encourage them to visit the casino and gamble more. These promotions are targeted in nature with a measure of the gambling volume of the consumer in the immediate quarter before the promotion used to decide whether to send a particular promotion to a consumer or not. Specifically, consumers are classified into tiers based on their “average daily worths” (ADWs) in the previous period, with discrete thresholds defining the various tiers. ADW is a measure of the theoretical amount a person would have bet in the casino in a day if their wins were at the long range averages for the games they played. This measure is not reported to consumers and is very hard for them to calculate on their own.

For instance, all consumers with ADW between $500 and $1000 are classified into one tier and offered a particular set of promotional offers. Consumers with ADW between $300 and $500 might be classified into a different tier. Consumers do not observe ADW and hence are unable to self-select into tiers. From a RD and RDES perspective, this helps ensure continuity of the score at the threshold. Consumers' visits and gambling behavior for the duration of the promotional offers are tracked. The casino operator is interested in the incremental impact of the promotions in terms of several outcome variables such as amount gambled and days gambled. We note that this problem setting belong to a commonly observed type of marketing program where the firm has a loyalty program and selects customers to receive promotions based on the loyalty tiers.

Establishing the efficacy of the promotional programs by measuring the incremental effect of the promotions is of broad interest to the marketing community. Naive regression estimates of incremental impact would lead to biased estimates since customers who are selected for the promotions have different underlying propensity for visiting the casino and the amounts gambled compared to those who are not. The treatment effect of promotions can be measured using a RD design with the ADW as the score variable.

To apply RDES according to an embodiment of the present invention to this problem, we proceed as if the score variable and the thresholds for classifying consumers into tiers are unobserved. This type of a situation is not uncommon in marketing applications where ex post all that is known to an analyst is that customers were selected based on some variables. In this situation, we would not be able to use a standard RD design. We can use the RDES method according to an embodiment of the present invention provided we have a set of variables that explain the score function, albeit imperfectly. Note that the score used for deciding which consumers get the promotional offer is the average daily worth (ADW). This variable is obtained using a formula that combines information on the number of days that the consumer visited the casino during the quarter under consideration, the number of days in which gambling activity was recorded and the average daily volume of play, in addition to other variables.

The formula used for computing ADW is unobserved to us, as are the factors other than these observed variables which go into the ADW formula. We consider a context where the analyst observes these variables that are components of the score variable—ADW—but not the score variable itself. We use these observed variables as the covariates in the first stage of our RDES approach according to an embodiment of the present invention to find the estimated score for each consumer. We then use the estimated score to implement an RD design to uncover the treatment effects. We measure treatment effects for two outcomes variables that the casino may be interested in—the amount of gambling during the promotional period in total, and the total number of days that the consumer visited the casino during that period and had any gambling activity.

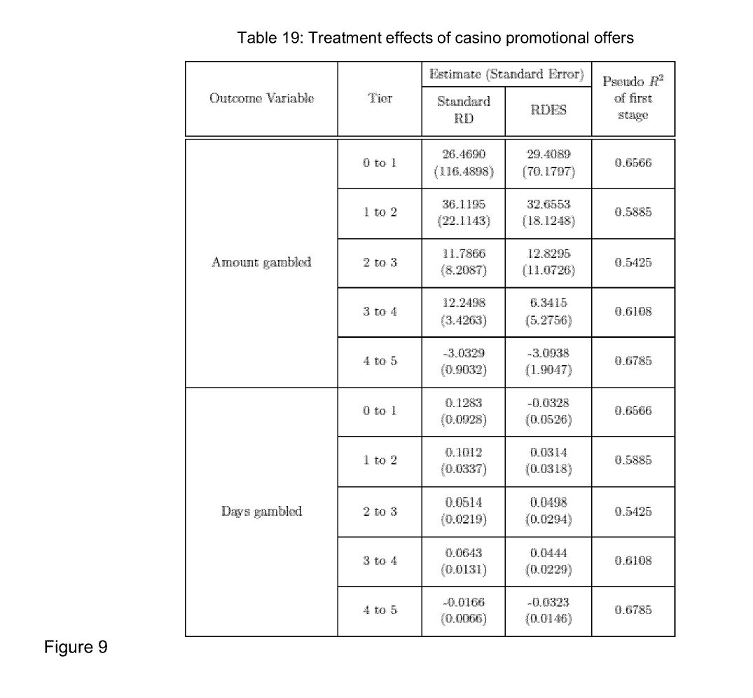

The standard RD estimates and the RDES estimates using our two-stage approach according to an embodiment of the present invention are presented in Table 19 (shown in FIG. 9). The treatment is the change in promotion when moving from one tier to the next. We report the treatment effects for each pair of adjacent tiers. Many of the effects are statistically insignificant; we focus on those estimates that are significant at least at the 90% confidence level for the two-stage RD.

Focusing first on the effect of promotion on the amount gambled, the two-stage RD estimates are significant for two of the tier pairs—1 to 2 and 4 to 5. The signs for the estimates are the same as the ones for the standard RD. Further, the magnitudes of the estimated effects are very close to those for the standard RD in both cases, with the RD estimates lying within a standard deviation of the RDES estimates. When the outcome is the number of days gambled, the treatment effects are significantly estimated (at the 90% level) using two-stage RD for three of the tier pairs—2 to 3, 3 to 4 and 4 to 5. Once again, the estimated effects are very close to those for standard RD, with the signs of the estimates being the same in all cases, the magnitudes of the RD estimates for two cases (tier 2 to 3 and 3 to 4 effects) lying within a standard deviation of the RDES estimates and a third case where the RD estimate lies just above one standard deviation from the RDES estimate (tier 4 to 5 effect).

We next look at cases where RD estimates are significant, but no significant effects are picked up by RDES according to an embodiment of the present invention. There are only two such cases, one for the tier 3/4 effect for the amount gambled, and the other being the tier 1/2 effect for the number of days gambled. In both of these cases, the signs of the RDES coefficients are the same as those of the RD coefficients, although the RDES estimates are insignificant. In summary, while there may be cases of type-II errors where the RDES estimator fails to pick up a true effect, there are no cases of type-I errors where the RDES estimator falsely picks up a non-existing effect.

The analysis for this application further validates our RDES approach according to an embodiment of the present invention. The estimated effects are of the same sign in all cases and have very similar magnitudes as standard RD in almost all the cases. This application provides validity for our approach in a real world context, going beyond that established by the Monte Carlo simulations.

Search Engine Advertising

The application we present here is in the context of advertising on search engines, specifically on Google. Advertising on search engines is shown along with the organic search results when consumers search for a keyword phrase. The search engine conducts an online automated auction for each set of keywords to decide which advertisements would be shown. Advertisers submit bids for each set of keywords they want their advertising for. All bidders are ranked by the search engine on a variable termed AdRank.

This is simply the following

AdRank=Bid×QualityScore (21)

The variable QualityScore is a score given by the search engine to each advertiser-keyword combination and is a function of the expected click-through rate for that advertiser and other factors including the contents of the landing page on the advertiser's website. While Google does not reveal the exact method by which it computes the QualityScore for each advertiser, it is a widely held view that it is primarily a function of expected click-through rates. This is estimated by Google using historical data, combined with some degree of experimentation. There is considerable variation in QualityScore on a day-to-day basis due to factors such as price promotions, the exact words on the advertisement itself, etc. The search engine orders the advertisers in decreasing order of AdRank with the advertiser placed highest on this measure getting the highest position in the search advertising results.

The dataset in this empirical application comes from an advertiser, which is an online retailer of consumer durable goods. These goods are purchased relatively infrequently by consumers, with retail price of products averaging in the few hundreds of dollars. The product category is largely purchased online, with one major competitor for this advertiser which is also an online store. A unique feature of this dataset is that this retailer acquired three of its major previous competitors, and we have historical information for these competitors as well, each of which also placed advertisements on the search engine. For each advertiser-keyword combination, we observe a number of variables on a daily basis. These include the position of the advertisement, the amount bid by the advertiser, the QualityScore reported by Google, and several outcome measures such as click-through rates, conversion rates (the proportion of clicks that got converted into sales) and the dollar value of sales.

The treatment effects of interest in this context are the effects of position on outcomes listed above. Measuring the causal effects of position is quite difficult in this context. Since the position is not exogenous, the correlational results of position and outcomes can be misleading. For instance, the firm might bid higher in order to get a higher position in the search engine advertising results when it has an ongoing promotional event. It would have a higher position but also a higher level of sales even if its position had been lower. Hence, we might misattribute the promotional effect on position. Conversely, the focal firm might not change its bids, but its competitors might increase their bids when they have promotions. Presumably, consumers who likely do comparison shopping in this category, would be less likely to purchase at the focal firm given the promotion at its competing retailer, and this effect could be misattributed to the lower position of the focal firm in the search advertising results.

There are unobservable factors that can affect both the outcome and the position in search advertising results, and cause a bias in the estimates. This is a context which is expensive and difficult to run an experiment in as well. This is because the search advertising results are the outcome of an auction. While the advertiser could control its own bid, it could not do so for its competitors. Hence, finding causal position effects through traditional means is difficult.

An RD design could potentially be implemented in this context. The RD results from the fact that the position is based on AdRank with a discrete cutoff. When the AdRank for an advertiser is higher than that for its adjacent advertiser, it is placed higher than it. Else, it is placed below it. Considering the difference in AdRank for an advertiser in a particular position and the competing advertiser in the position just below it, the advertiser wins the bid for the position when this difference (say ΔAdRank) is positive, and loses the bid when it is negative.

Comparing the outcomes for the two positions (even after controlling for the advertiser-keyword combination) gives correlational as opposed to causal effects as already pointed out. If we compare the observations where the advertiser wins the bid for a position a very small margin to those where the advertiser loses the bid by a small margin, we would obtain causal effects under the condition that whether an advertiser wins the bid by a small amount or loses by a small amount is random. This randomization is achieved by the fact that while advertisers observe their own bids and quality scores, they do not observe these for competitors even ex-post. The limiting case of when the advertiser loses the bid constitutes a valid control group for the limiting case of when the advertiser wins the bid. This gives us the treatment effect at that margin.

In order to implement an RD design, one would need to know the AdRank for all the advertisers. Typically, Google observes everybody's AdRank but does not share competitors' AdRank with any advertiser. The unique feature of our dataset where we observe AdRanks not just for one firm but for a set of competitors, allows for the implementation of an RD design to measure the treatment effects of interest.

Typically, Google provides AdRank information to an advertiser but not its competitors. This is an important aspect making an RD design feasible for measuring the causal effects of position on outcomes of interest. This same aspect of the information provided by Google to advertisers makes it hard for typical advertisers to measure the treatment effects using standard RD, since the score—ΔAdRank—is typically unobserved. But since they observe their own bids and quality scores and their own AdRanks, they observe components of the score. While a standard RD design is typically not feasible, the RDES approach according to an embodiment of the present invention could be used to uncover the treatment effects of interest.

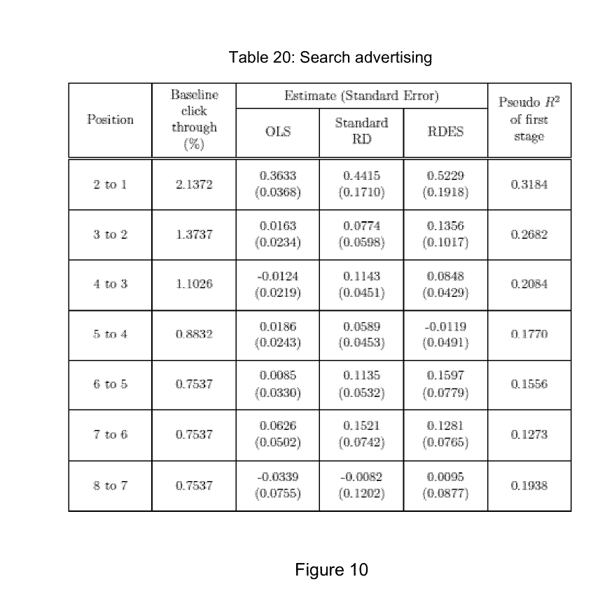

The OLS, standard RD and RDES estimates of the effect of position, are presented in Table 20 (shown in FIG. 10). These effects measure how moving from one position to the next higher position in the search advertising affects the click through rates for the advertisement. The OLS estimates reflect mean comparisons of click through rates across adjacent positions. These estimates may suggest that there are significant position effects only at position 1. These estimates may be unreliable due to potential selection in position due to strategic bidding behavior by firms. The RD estimates correct for these selection issues by considering only observations very close to the threshold that define whether an advertisement is placed at the next higher position or not.

These estimates are made possible by the fact that we observe the AdRanks for competing firms in the dataset. We use observations where the AdRank of the advertiser in the higher position as well as that in the lower positions are observed. The RD estimates suggest statistically significant position effects not just at the top most position but also at positions 3, 6 and 7. The RDES estimates for these position effects are also reported in the table. These estimates use only the focal advertiser's information but not that of competitors. We find that the RDES estimates according to an embodiment of the present invention suggest position effects at the same positions as the RD estimates. While the RDES estimates may be, in general, less significant than the RD estimates, they suggest significant effects (at least at the 90% level) at positions 1, 3, 6 and 7—the same positions for which the RD estimates suggest significant effects. The magnitudes of the RDES estimates are close to those for the RD estimates with the RDES estimates lying within a standard deviation of the RD estimates in each of these four positions. This provides further validation for the RDES estimator in a real-world context.

We have presented a method according to an embodiment of the present invention for estimating causal treatment effects in contexts where the treatment is based on whether an underlying continuous variable crosses a threshold. When the underlying variable and the threshold defining treatment are observed, regression discontinuity estimates can be obtained to measure the causal effects of treatment. An embodiment of the present invention pertains to cases where either the score or the threshold is not fully observed, but other variables (including potentially components of the score) that define treatment are observed. An embodiment of the present invention involves first estimating a choice model, like a probit model or logit model, with treatment as the dependent binary variable, and observed components of the score or other variables explaining treatment are the covariates. Then, the values of the underlying latent utilities are estimated for every observation. This underlying utility is treated like a score variable, and an RD design implemented. We demonstrate that such an estimator obtains the causal effects of interest under certain regularity conditions that are typically met in practice.

Embodiments of the present invention provide a significant advancement to the methodology of regression discontinuity, extending it to contexts where the score or the threshold defining treatment are unobserved. Such contexts abound in marketing and industrial organization contexts where several decisions made by firms rely on heuristic rules involving discontinuities. Furthermore, all the variables that enter the score function are typically not observed, or the relationship between the variables and the score are unobserved and cannot be inferred by the analyst. The methodology according to an embodiment of the present invention can be applied to such contexts where standard regression discontinuity may be infeasible. Embodiments of the present invention further the understanding of treatment effects in the contexts of casino gambling and search advertising for example. The latter context would particularly benefit from the methodology because it is difficult to experiment and randomize positions in the search advertising results, and alternative econometric techniques such as instrumental variables regressions are typically infeasible as well due to the non-availability of suitable instruments and/or exclusion restrictions. We find in both these contexts that RDES estimates are very close to the RD estimates. Both these empirical contexts provide strong support for the validity of the RDES estimator.

Applications

Having fully disclosed the present invention, those of ordinary skill in the art will find many other applications for embodiments of the present invention. As examples, below are described certain applications for the present invention.

Some search engines offer further analytics packages whose use can be extended using embodiments of the present invention. For example, Google offers Google analytics. Embodiments of the present invention relating to RD and RDES can be included as a feature in Google analytics. There are reports in the public domain that Google analytics boosted Google's revenue by billions of dollars because it enabled advertisers to more accurately measure the value of Google advertising. To the extent that the methods according to embodiments of the present invention can enable advertisers to more accurately measure the value of position, then search engines such as Google can benefit.

Advertisers and search marketing agencies have various traditional techniques to measure the value of search advertising and allocate incremental dollars. The methods according to embodiments of the present invention can help them obtain improved benefits from their spending.

Analytics platforms such as Ominture (Adobe) and Core Metrics (IBM) offer advertisers a data repository and an analytics platform to capture all website activity including advertising. These platforms can benefit from adding embodiments of the present invention. For example, features can be added that enable automated measurement of causal advertising effects.

Firms that are focused on large data solutions can benefit from embodiments of the present invention. The invention is computationally efficient and allows fast turnaround in a large data settings. Embodiments of the present invention can be scaled for such applications.

It should be appreciated by those skilled in the art that the specific embodiments disclosed above may be readily utilized as a basis for modifying or designing other algorithms or systems. It should also be appreciated by those skilled in the art that such modifications do not depart from the scope of the invention as set forth in the appended claims.

What is claimed is:

1. A method for determining a position effect of a first advertising slot relative to a second advertising slot wherein the first advertising slot is of lower rank than the second advertising slot, comprising:
selecting a plurality of observations by which to measure the position effect of the first advertising slot;
selecting a bandwidth for a regression discontinuity algorithm;
collecting observations with scores within the selected bandwidth;
controlling for fixed effects; and
computing a position effect using the regression discontinuity algorithm.

2. The method of claim 1 further comprising testing for the robustness of the selected bandwidth.

3. The method of claim 1, wherein the selected observations are used to measure a position effect of the second advertising slot.

4. The method of claim 1, wherein the bandwidth is selected to be from 1% to 10% of a standard deviation of the selected observations.

5. The method of claim 1, wherein controlling for fixed effects is performed using a computed mean-difference value of a plurality of outcome values.

6. The method of claim 1, wherein computing the position effect is performed using two limiting values of a mean difference measurement on two sides of a predetermined cutoff

7. The method of claim 6, wherein the measurement is a click through rate.

8. The method of claim 1, wherein computing the position effect is performed using a local polynomial regression.

9. The method of claim 1, further comprising computing a measure of robustness for the position effect.

10. The method of claim 9, wherein the measure of robustness is performed by varying the bandwidth.

11. A computer-readable medium including instructions that, when executed by a processing unit, cause the processing unit to implement a method for determining a position effect of a first advertising slot relative to a second advertising slot wherein the first advertising slot is of lower rank than the second advertising slot, by performing the steps of
selecting a plurality of observations by which to measure the position effect of the first advertising slot;
selecting a bandwidth for a regression discontinuity algorithm;
collecting observations with scores within the selected bandwidth;
controlling for fixed effects; and
computing a position effect using the regression discontinuity algorithm.

12. The computer-readable medium of claim 11 further comprising testing for the robustness of the selected bandwidth.

13. The computer-readable medium of claim 11, wherein the selected observations are used to measure a position effect of the second advertising slot.

14. The computer-readable medium of claim 11, wherein the bandwidth is selected to be from 1% to 10% of a standard deviation of the selected observations.

15. The computer-readable medium of claim 11, wherein controlling for fixed effects is performed using a computed mean-difference value of a plurality of outcome values.

16. The computer-readable medium of claim 11, wherein computing the position effect is performed using two limiting values of a mean difference measurement on two sides of a predetermined cutoff

17. The computer-readable medium of claim 16, wherein the measurement is a click through rate.

18. The computer-readable medium of claim 11, wherein computing the position effect is performed using a local polynomial regression.

19. The computer-readable medium of claim 11, further comprising computing a measure of robustness for the position effect.

20. The computer-readable medium of claim 19, wherein the measure of robustness is performed by varying the bandwidth.

21. A computing device comprising:
a data bus;
a memory unit coupled to the data bus;
at least one processing unit coupled to the data bus and configured to
select a plurality of observations by which to measure the position effect of the first advertising slot;
select a bandwidth for a regression discontinuity algorithm;
collect observations with scores within the selected bandwidth;
control for fixed effects; and
compute a position effect using the regression discontinuity algorithm.
